(19) United States
(12) Patent Application Publication
(10) Pub. No.: US 2002/0064218 A1
(43) Pub. Date: May 30, 2002

(54) Data link for multi protocol facility distributed communication hub

(75) Inventors: W. Paul Willes, Alpine, UT (US); Samuel C. Kingston, Salt Lake City, UT (US); Ronald S. Leahy, Salt Lake City, UT (US); Douglas A. Steck, Alpine, UT (US)

Correspondence Address: Lloyd W. Sadler, Parsons Behle & Latimer, Suite 1800, 201 South Main Street, Salt Lake City, UT, 84111, US

(73) Assignee: Phonex Broadband Corporation

(21) Appl. No.: 09/895,614

(22) Filed: Jun. 29, 2001

Related U.S. Application Data
(60) Provisional application No. 60/215,213, filed on Jun. 29, 2000.

(51) Int. Cl. H04B 1/38

(52) U.S. Cl. 375/219

(57) ABSTRACT

A system for providing communications between a wide variety of communication devices using the AC power line within a building or facility without requiring dedicated hard wiring. This invention is designed specifically to accommodate such devices as gateways, PCs, telephone devices, RF equipment, home automation devices and audio-visual devices.

### CROSS REFERENCE TO RELATED APPLICATIONS

This patent application is based on U.S. Provisional Patent Application No. 60/215,213 filed on Jun. 29, 2000, copending at the filing date of this present patent application and priority is hereby claimed thereto.

### BACKGROUND OF INVENTION

1. Field of the Invention

This invention relates to electronic communication systems and devices that provide communication between a wide variety of devices. More specifically, this invention relates to electronic communication systems and devices between a wide variety of communication devices within a building or facility without requiring dedicated wiring.

2. Description of Related Art

A variety of electronic communication systems and devices have been developed and are widely used to facilitate wireless communication. Traditionally, such systems require use of a single communication protocol and/or work only with a very limited selection of devices. For general background material, the reader is directed to the following U.S. Pat. Nos., each of which is hereby incorporated by reference in its entirety for the material contained therein: U.S. Pat. Nos. 4,200,930, 5,485,455, 5,491,694, 5,509,123, 5,521,910, 5,621,727, 5,708,659, 5,719,862, 5,740,230, 5,740,231, 5,754,552, 5,761,201, 5,769,527, 5,790,546, 5,799,041, 5,815,492, 5,825,772, 5,856,975, 5,864,554, 5,867,494, 5,867,495, 5,872,779, 5,872,784, 5,878,221, 5,887,187, 5,914,955, 5,940,478, 5,982,857, 5,999,525, 6,011,776, 6,016,401, 6,026,088, 6,031,895, 6,064,723, 6,067,557, 6,070,243, and 6,072,803.

### SUMMARY OF INVENTION

It is desirable to provide a communications system that accommodates multi-port, multi-protocol access to a wide variety of electronic communications devices within a facility and/or building without requiring dedicated wiring.

It is the general object of this invention to provide a communication system that makes use of the AC power line as the communications channel.

It is a further object of this invention to provide a communication system that is compatible with Ethernet/USB devices.

It is a still further object of this invention to provide a communication system that is compatible with DSL modem devices.

It is a still further object of this invention to provide a communication system that is compatible with V.90 modem devices.

It is another object of this invention to provide a communication system that is compatible with telephone communication systems.

A further object of this invention is to provide a communication system that is compatible with Desk Top PC communications.

A still further object of this invention is to provide a communication system that is compatible with lap top computer communications.

Another object of this invention is to provide a communication system that is compatible with facsimile communication systems.

It is a further object of this invention to provide a communication system that is compatible with RF (Blue Tooth) communications protocols.

It is another object of this invention to provide a communication system that is compatible with Home Automation bridge communication devices.

A further object of this invention is to provide a communication system that is compatible with Audio/Video component bridge communication devices.

These and other objects of this invention will be readily apparent to those of ordinary skill in the art upon review of the following drawings, detailed description and claims. In the preferred embodiment of this invention, the communication system of this invention makes use of a novel high rate modulator and a novel high rate demodulator in communication with the communication device of interest and the AC power line.

### BRIEF DESCRIPTION OF DRAWINGS

In order to show the manner that the above recited and other advantages and objects of the invention are obtained, a more particular description of the preferred embodiments of this invention, which is illustrated in the appended drawings, is described as follows. The reader should understand that the drawings depict only present preferred and best mode embodiments of the invention, and are not to be considered as limiting in scope. A brief description of the drawings is as follows:FIG. 1 is a top level system block diagram of the preferred communication system of this invention.

FIG. 2 is a block diagram of the preferred modulator of this invention.

FIG. 3 is a block diagram of the preferred demodulator of this invention.

FIG. 4 is a detailed block diagram of the preferred autoscale function used in the FFT of this invention.

FIG. 5 is a detailed schematic of the pass processing pipeline circuit preferred in this invention.

FIG. 6 is a detailed block diagram of the preferred SNR Estimator of this invention.

FIG. 7 is a detailed block diagram of the preferred Time Differential Decoder of this invention.

FIG. 8 is a detailed block diagram of the preferred Time Differential Encoder of this invention.

FIG. 9 is a detailed schematic of the preferred AC power line interface circuit of this invention.

FIG. 10 is a detailed block diagram of the preferred phase shifter of this invention.

FIG. 11 is a detailed schematic of the preferred sense inverter of the phase shifter of this invention.

FIG. 12 is a detailed schematic of the preferred real shift 33.7, 11.3 of the phase shifter of this invention.

FIG. 13 is a detailed schematic of the preferred real shift 8.53, 2.84 of the phase shifter of this invention.

FIG. 14 is a detailed schematic of the preferred real shift 2.84, 1.43, 0 of the phase shifter of this invention.

FIG. 15 is a listing of a preferred phase shift function code used in this invention.

FIG. 16 is a plot of the amplitude error vs the phase command of the phase shifter of this invention.

FIG. 17 is a plot of the amplitude error vs phase command of a preferred 8 bit complex multiply phase shifter of this invention.

FIG. 18 is a plot of the phase error vs the phase command of the phase shifter of this invention.

FIG. 19 is a plot of the phase error vs the phase command of the preferred 8 bit complex multiply phase shifter of this invention.

FIG. 20 is a detailed schematic of the preferred quarter band ×4 up/down sampler and filter of this invention.

FIG. 21 is a detailed schematic of a preferred half rate filter of this invention.

FIG. 22 is a detailed schematic of a preferred quarter rate filter of this invention.

FIGS. 23a and b provide a mathematical derivation of the 2-bit FFT and FIG. 23c is a detailed schematic of a butterfly circuit of a FFT.

FIG. 24 is a detailed schematic of a dragonfly circuit of a FFT.

FIG. 25 is a detailed schematic of an FFT, acquisition and time differential demodulator of this invention.

FIG. 26 is a detailed schematic of a preferred dragon fly circuit of the FFT of this invention.

FIG. 27 is a plot showing the white noise performance of a Walsh Encoder vs a repeat 4 White Gaussian code.

FIG. 28 is a listing of the preferred program code used in the finding the 16ary error for nbe erasures.

FIG. 29 is a plot of the erasure performance for (16,4) codes.

FIG. 30 is a plot of the hard error performance for (16,4) codes.

FIG. 31 is a plot of the Walsh coding bit error rate vs SNR for each channel.

FIG. 32 is a plot of the Walsh coding bit error rate vs EbNo.

FIG. 33 is a detailed schematic of the preferred fast 16 symbol Walsh transformer preferred in this invention.

FIG. 34 is a time plot of Walsh encoding.

FIGS. 35a-af are the current preferred electronic schematics of the preferred embodiment of this invention.

Reference will now be made in detail to the present preferred embodiment of the invention, examples of which are illustrated in the accompanying drawings.

### DETAILED DESCRIPTION

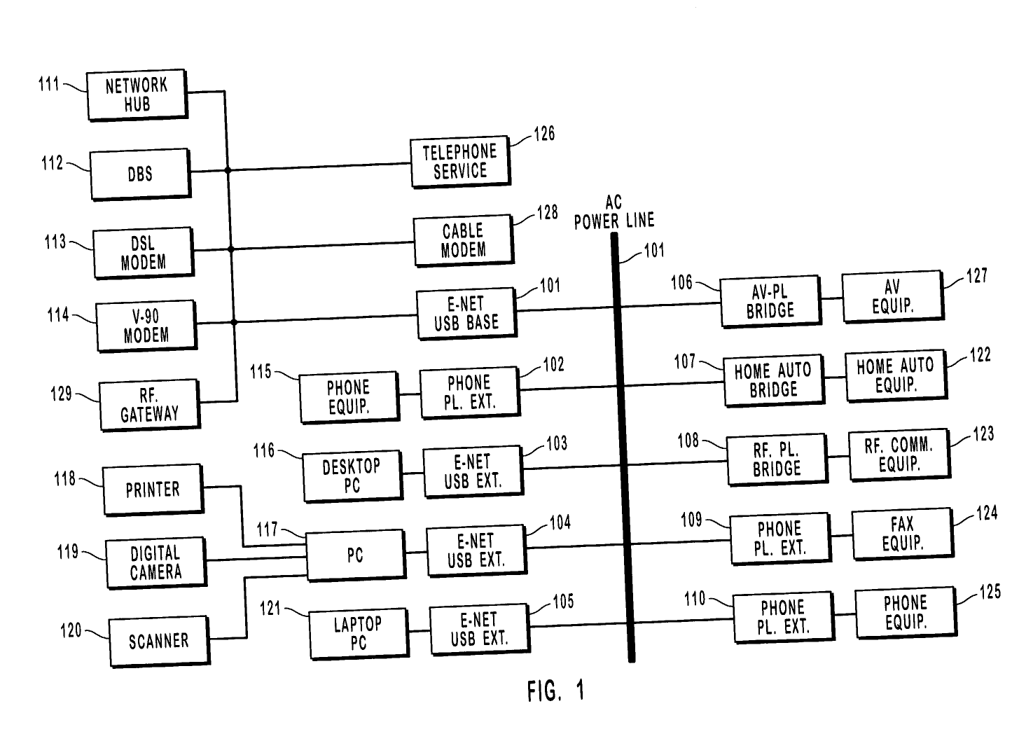

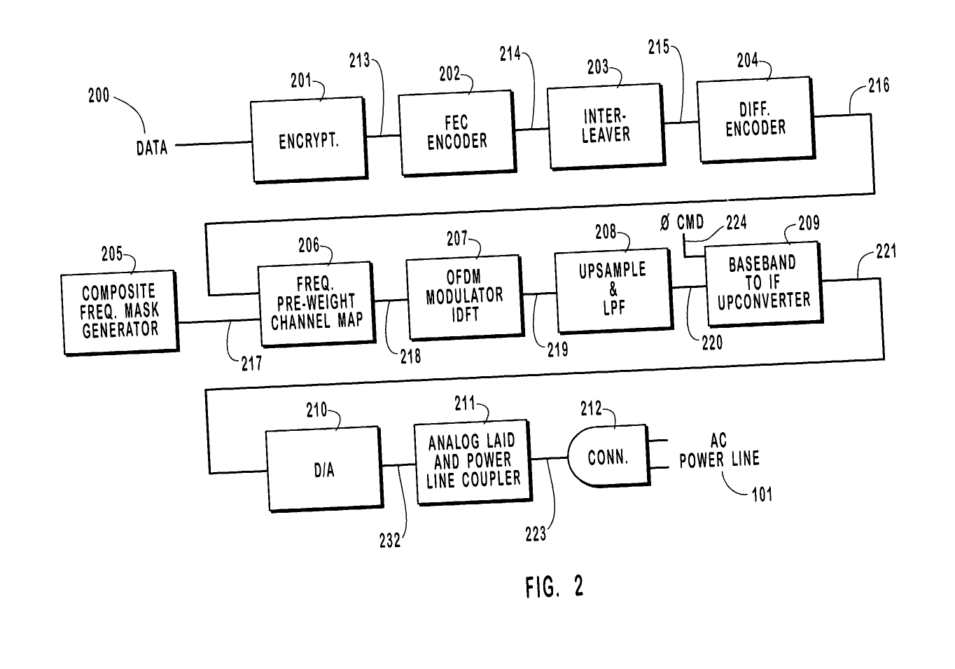

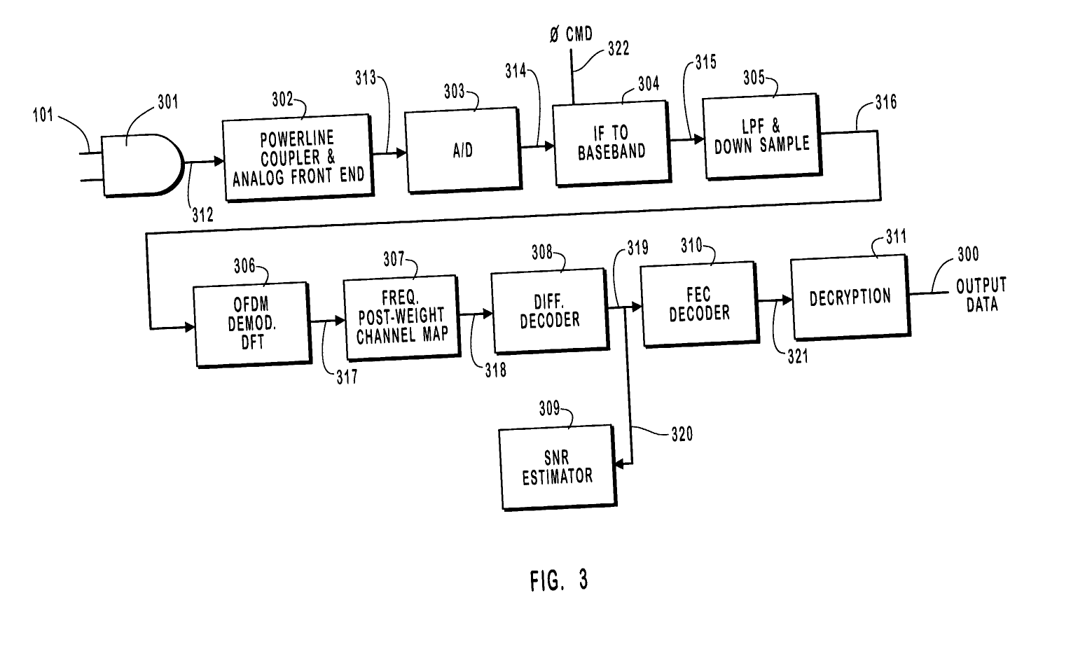

FIG. 1 is a top level system block diagram of the preferred communication system of this invention. In its preferred embodiment this invention makes use of the AC power line 101, typically found within homes and other structures, as a communication channel. Alternative embodiments may substitute RF wireless for the AC power line 101. Such substitution, although not considered the preferred embodiment, is an alternative communication channel envisioned by the inventors. Connected to the AC power line 101 is a base unit 101 and one or more extension units 102, 103, 104, 105, 106, 107, 108, 109, 110. The base unit 101 and the extension units 102, 103, 104, 105, 106, 107, 108, 109, 110 may be adapted for specific purposes and/or for use with specific electronic devices. In the preferred embodiment of this invention, each base unit 101 and extension unit 102, 103, 104, 105, 106, 107, 108, 109, 110 contains the key components of this invention, specifically, the modulator (shown in FIG. 2) and the demodulator (shown in FIG. 3). In the embodiment shown in this FIG. 1, the base unit 101 is adapted as an Ethernet/USB base unit. Besides providing the control for the power line communication channel 101, the base unit 101 also can provide an electronic connection to a wide variety of communication gateways, including but not necessarily limited to: a network hub 111, a DBS 112, a DSL modem 113, a V.90 modem 114, standard telephone service 126, a cable modem 128 and an RF gateway. A phone equipment power line extension 102 provides the communication interface between telephone equipment 115 to the power line communication channel 101. An Ethernet/USB extension unit 103 provides the communication interface between a desk top personal computer 116 and the power line communication channel 101. Another Ethernet/USB extension unit 104 provides the communication interface between a second personal computer 117, which is connected to a printer 118, a digital camera 119 and/or a scanner 120, to the power line communication channel 101. A further Ethernet/USB extension unit 105 provides the communication interface between a laptop personal computer 121 to the power line communication channel 101. An audio-visual power line bridge extension 106 provides the communication interface between audio-visual equipment 127 and the power line communication channel 101. A home automation bridge extension 107 provides the communication interface between home automation equipment 122 and the power line communication channel 101. An RF-power line bridge extension 108 provides the communication interface between RF communication equipment 123, including wireless telephones and the like, and the power line communication channel 101. Another telephone/power line extension unit 109 provides the communication interface between facsimile equipment 124 and the power line communication channel 101. A further telephone/power line extension unit 110 provides the communication channel between additional telephone equipment 125 and the power line communication channel 101. While this invention provides a system for communication between a wide variety of devices, as exemplified by this FIG. 1, over the AC power line communication channel, it should not be interpreted that this invention is limited only to the devices shown in this figure, nor does this system require that all of these devices be connected. In alternative embodiments this invention may be used to provide a communication system between multiple telephone devices only, or alternatively between multiple computer devices only. Still other alternative embodiments may be used to communicate to and from home automation equipment, such as heating, air conditioning, lights, alarms and the like. Further embodiments of this invention may be used to provide communication to and between audio-visual equipment. This invention provides the communication system herein described, between some, all or other communication devices, without requiring dedicated wiring between the devices by using, in the preferred embodiment, the existing AC power line communication channel that is available and used to power the devices.

FIG. 2 shows a block diagram of the preferred modulator of this invention. Data 200, received from the specified communication device, which is to be communicated over the AC power line 101 can be any digitized data from any known protocol. The data 200 is packetized and transmitted in serial typically from a MAC controller. The data 200 is received by an Encryptor 201, which in its preferred embodiment employs an RC 4, DES 56 or similar encryption to provide security and/or communications privacy. The encrypted data 213 from the Encyptor 201 is received by a Forward Error Correction (FEC) Encoder 202 which typically and preferably uses either a Turbo Product Code, for high efficiency, or a Walsh function, which has lower efficiency but also has lower cost. The FEC Encoder 202 outputs and encoded signal 213 which in turn is received by a row-column Interleaver 203 producing an interleaved signal 215. The interleaved signal 215 is received by a Differential Encoder 204. In this preferred embodiment of the invention the Differential Encoder 204 encodes based on time for OFDM modulation. Alternatively, the Differential Encoder 204 can be used to encode based on frequency. The Differential Encoder 204 produces a differentially encoded signal 216 that is received by a Frequency PreWeight and Channel Mapper 206. The Frequency PreWeight and Channel Mapper 206 uses a channel selector signal 217 from a Composite Frequency Mask Generator 205 to give the relative gain by channel. The Frequency PreWeight and Channel Mapper 206 weights the power in frequency bins relative to the received differentially encoded signal 216 to compensate for subsequent low pass filtering (LPF). The resulting signal 218 is received, in the preferred embodiment, by an OFDM Modulator 207 employing an IDFT Fast Fourier Transform (FFT) using a digital phase shifter, producing a transformed signal 219. The transformed signal 219 is received by an Upsample and Low Pass Filter (LPF) circuit 208. Preferably, the Low Pass Filter is gate efficient. The Upsample and LPF generates a filtered signal 220 that is received by a Base Band to IF Upconverter 209. Essentially, the Base Band to IF Upconverter 209 is a digital phase shifter. The Base Band to IF Upconverter 209 receives a phase command signal 224 which is used in phase shifting the filtered signal 220. The phase shifted output 221 of the Base Band to IF Upconverter 209 is received by a Digital to Analog (D/A) converter 210. Preferably, the D/A 210 has 8-10 bits of resolution. The resulting analog signal 222 is received by an Analog Gain and Powerline Coupler 211 in which the automatic gain control (AGC) is fixed and the analog signal 222 is coupled onto the AC power line 101, typically and preferably via a standard wall plug/outlet combination 212. The preferred method of performing downcoverter elimination is to do the upsample/downsample filtering centered about the carrier frequency and then to eliminate the front-end high-rate downconversion. If the carrier is exactly 14 the upsample rate no downconversion is required. The waveform will allias to baseband when downsampled. Otherwise, the downconversion is done at the input to the FFT using its phase shifter. Alternativly, if the downconversion is not done, the rotated refrequency bins, are transformed and the rotation is undone on the data symbols. Bandpass filtering is preferably done in a 2 stage manner identical to the baseband filters. Preferably, the low pass filters have a zero for all even delay taps, except for the center tap. The first filter is a positive frequency pass instead of a low pass. The low pass taps are multiplied by exp(j*n/2*n) which makes the center tap unchaned and the odd taps imaginary but with the same magnitude as the low pass filter. This filter requires less than half the gates of the downconverted signal through a low pass since the input is all real. One additional adder is saved since the real center tap and the imaginary other taps do not have to be added. The second filter used in dependent on the selected center frequency. The low pass taps are multiplied by exp(4*n*j*fc*n) where fc is expressed as a fraction of the upsample rate. If fc is an integer multiple of 1/4 or 1/8 the taps are either real or imaginary with the same magnitude as the low pass taps. If fc is an integer multiple of 1/6, the odd taps are shifted by multiples of 45 degrees making them complex. By shifting all taps an additional 45 degrees all taps except the center become either real or imaginary. Other values of fc require complex taps doubling the size of the 2^{nd} filter and requiring that it be redesigned for simple weights as a function of the center frequency. This approach is lest costly than a high rate front end phase shifter.

FIG. 3 shows a block diagram of the preferred demodulator of this invention. Typically and preferably, the demodulator is connected to the AC power line 101 via a standard AC wall plug/outlet 301. The power line signal 312 is received by a Power Line Coupler & Analog Front End circuit, which couples the signal from the power line 101, factors off the desired signal and enables the AGC. The resulting received signal 313 is received by an Analog to Digital (A/D) converter 303. The preferred A/D converter 303 has 8-10 bits of resolution. A digital signal 314 is provided by the A/D converter 303 to an IF to Base Band Downconverter 304, which also receives a Phase Command signal 322. A digital phase shifter, the IF to Base Band Downconverter 304 uses the received Phase Command signal 322 to reverse the effects of the Base Band to IF Upconverter 209 of the modulator of this invention, thereby producing a downconverted signal 315. The downconverted signal 315 is received by a Low Pass Filter (LPF) and Downsampler 305, which preferably uses a gate efficient LPF. A resulting downsampled and filtered signal 316 is received by an OFDM Demodulator 306, which preferably is a digital Fast Fourier Transform (FFT), and produces a demodulated signal 317. The demodulated signal 317 is received by a Frequency PostWeight and Channel Demapper 307 which de-maps frequency bins into frequency power signals. The resulting power signals 318 are received by a Differential Decoder 308 for input to a Forward Error Corrected (FEC) Encoder 310, and a Signal-to-Noise Ratio Estimator 309 for channel mapping. Again, preferably, the FEC decoder typically and preferably employs a Turbo Product code or a Walsh Code, consistent with that used in the modulator. The resulting decoded signal 321 is received by a Decryptor 311 which decrypts the received signal, typically and preferably using a RC 4, DES 56 or similar decryption compatible with the Encryptor 201 of the modulator. The output 300 of the decryptor 311 is the data for use by the communication device of FIG. 1.

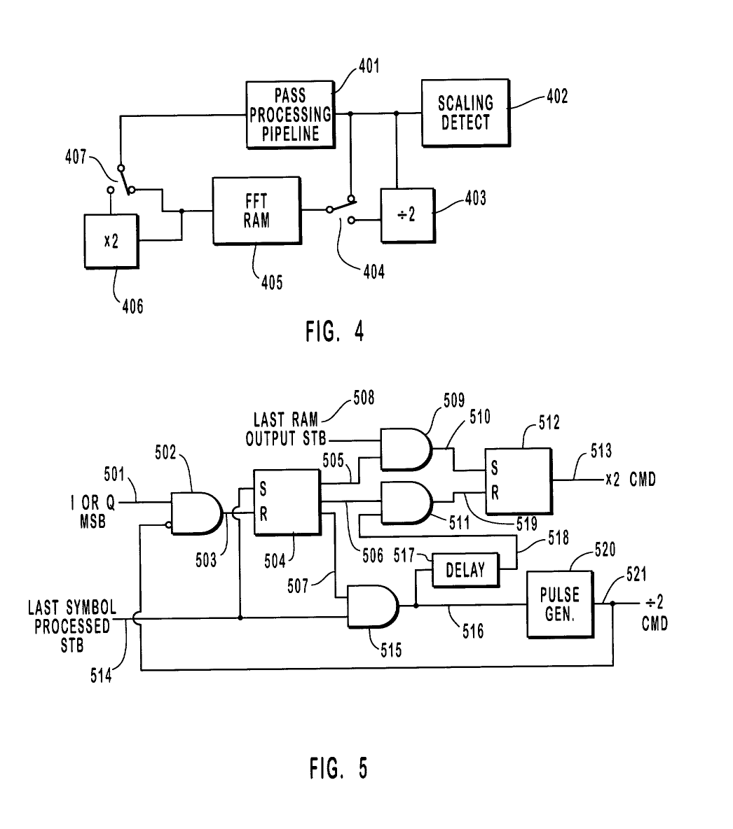

FIG. 4 shows a detailed block diagram of the preferred FFT used in the OFDM Modulator IDFT 207 and OFDM Demodulator DFT 306 of this invention. This autoscale FFT operates by setting the ×2 406 on the FFT RAM 405 output at the start of pass B, if no MSB is set or, alternatively, divide2 403 is set to the FFT RAM 405 from the start of pass A. Process outputs from the Pass Processing Pipeline 401 continue until the start of the pass B RAM outputs. ×2 is cleared if any most significant fit is set by the last processed output of pass A. divide2 is set for pipeline 401 delay clocks, if ×2 was set but cleared by the last processed output of pass A. The set and clearing of divide2 is accomplished using switch 404, while the set and clearing of ×2 is accomplished by using switch 407. A scaling detector 402 is connected to the output of the Pass Processing Pipeline 401.

FIG. 5 is a detailed schematic of the pass processing pipeline circuit 401 preferred in this invention. The I or Q MSB 501 is ANDed 502 with the inverse of the divide2 command 521. The result 503 of the AND 502 is connected to the reset line of a S-R flip/flop 504. The set line of the S-R flip/flop 504 is the Last Symbol Processed STB 514, which is also ANDed 515 with the third output 502 of the S-R flip/flop 504. The output of this second AND gate 515 is connected both to a delay line 517 and to a Pulse Generator 520. The output 521 of the Pulse Generator 520 is the divide2 command 521. The output 518 of the delay line 517 is ANDed 511 with the second output 506 of the S-R flip/flop 504, producing an output 519 as the reset line of a second S-R flip/flop 512. The Last RAM Output STB 508 is ANDed 509 with the first output 505 of the first S-R flip/flop 504, the output of which 510 is connected to the set line of the second S-R flip/flop 512. The ×2 Command 513 is the output of second S-R flip/flop 512.

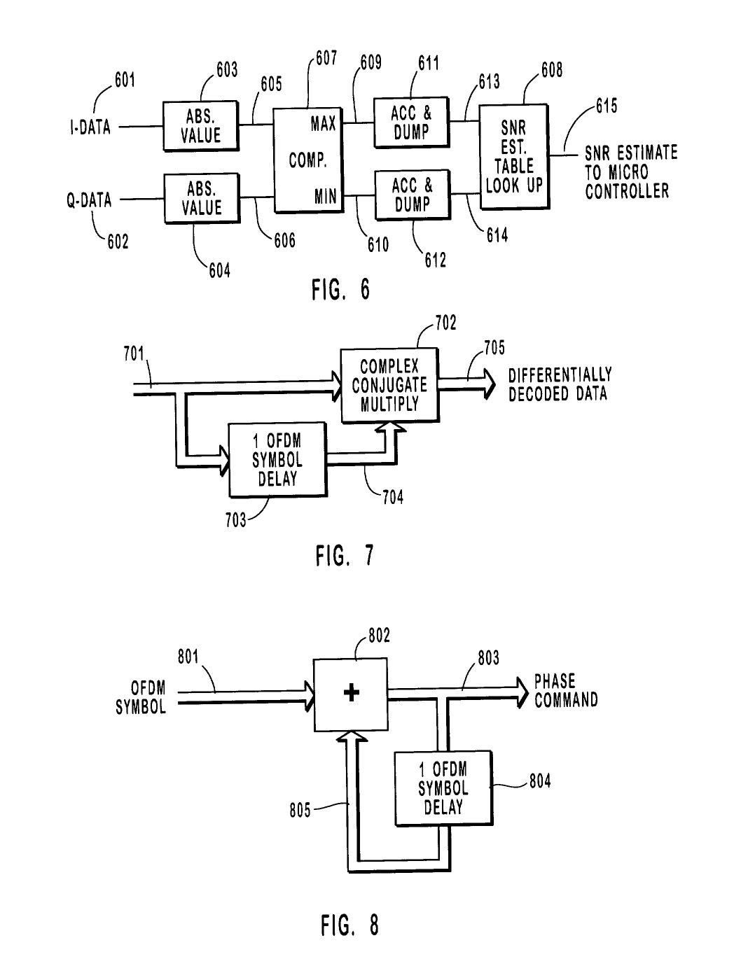

FIG. 6 shows a detailed block diagram of the preferred SNR Estimator 309 of this invention. I-Data 601 and Q-Data 602 are each received by absolute value circuits 603, 604. The calculated absolute values 605, 606 are received by a comparator 607. The comparator 607 computes the maximum and minimum of the calculated absolute values 605, 606. The maximum value 609 is summed and outputted, to the SNR estimate look up table 608, by an accumulate and dump circuit 611. Similarly, the minimum value 610 is summed and outputted, to the SNR estimate look up table 608, by an accumulate and dump circuit 612. The output of the SNR estimate look up table 608 is the SNR estimate provided to a micro controller in the FEC Decoder 319.

FIG. 7 shows a detailed block diagram of the preferred Time Differential Decoder 308 of this invention. Date received 701 is input to both a complex conjugate multiplier 702 and a 1 OFDM Symbol Delay circuit 703. The output 704 of the 1 OFDM Symbol Delay circuit 703 is the complex conjugate of the data received 701 and is input to the complex conjugate multiplier 702, the output 705 of the complex multiplier 702 consists of differentially decoded data.

FIG. 8 shows a detailed block diagram of the preferred Time Differential Encoder 204 of this invention. The OFDM Symbol 801 is received by a one cycle modulo adder 802. The output 803 of the modulo adder 802 is the phase command shown in FIG. 2 as 224. This output 803 is fed to a 1 OFDM Symbol Delay 804, the output 805 of which is the second input to the one cycle modulo adder 802. In this manner each data symbol is added to the previously transmitted symbol. Data is carried on the phase difference between the previous symbol and the current symbol. OFDM encoding is used in the preferred embodiment of this invention because OFDM provides for simultaneous transmission of multiple symbols at different frequencies.

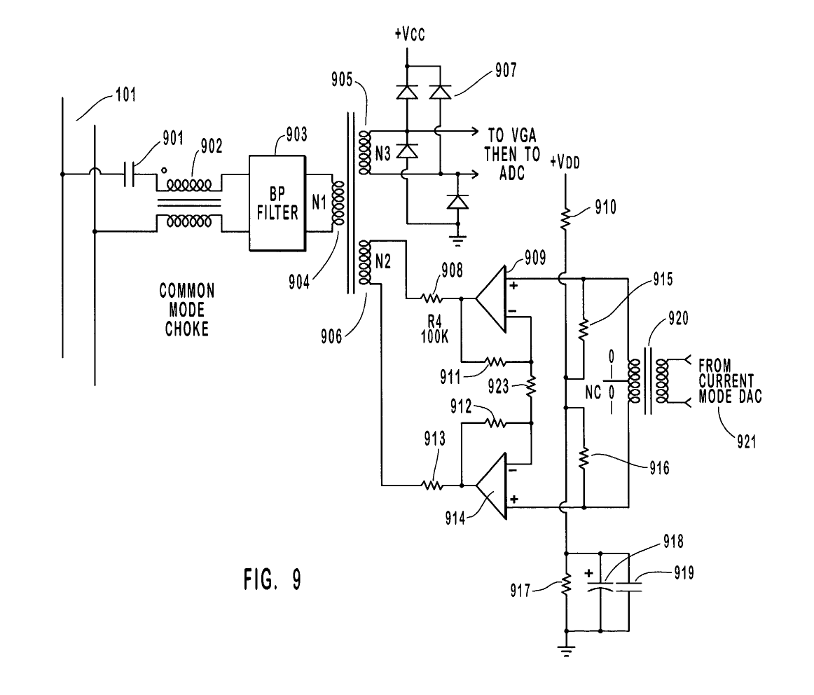

FIG. 9 shows a detailed schematic of the preferred AC power line interface circuit of this invention. Connected to the AC power line 101 is a safety capacitor 901 in series with a common mode choke 902. Connected to the second side of the common mode choke 902 is a band pass filter 905. Following the band pass filter 905 is a three coil 904, 905, 906 isolator. A surge suppress or circuit 907 connected to the second 905 coil is provided. A 15 to 20 dB gain amplifier, consisting of resistors 908, 91, 912, 923, 913, and two operational amplifiers 909, 914 is provided connecting to the third coil 906. Voltage shift and bias is provided by the resistors 910, 915, 916, while decoupling and filtering is provided with the parallel circuit of resistor 917 and capacitors 918, 919. A transformer 920 provides the connection between the amplifier circuit and a current mode DAC data.

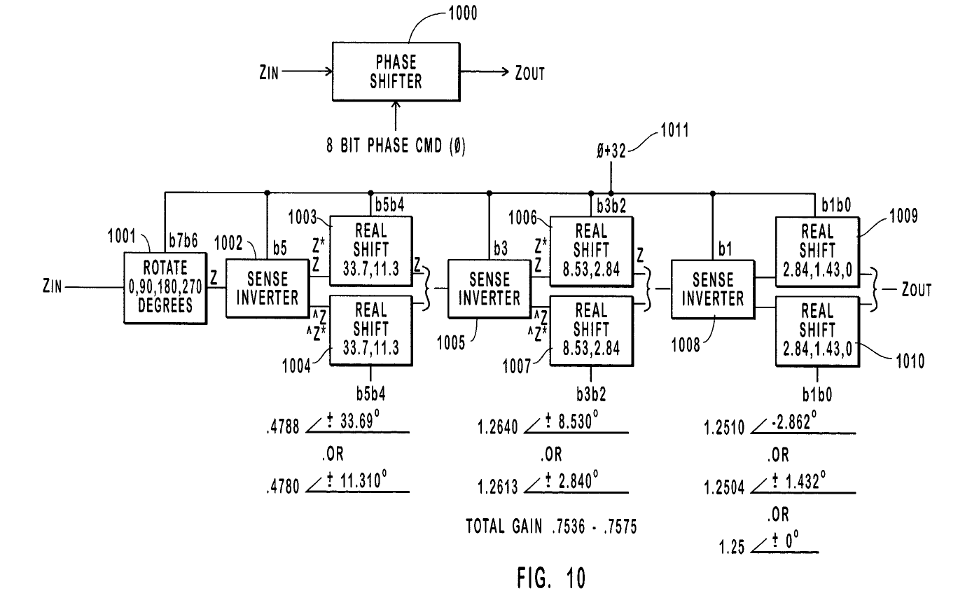

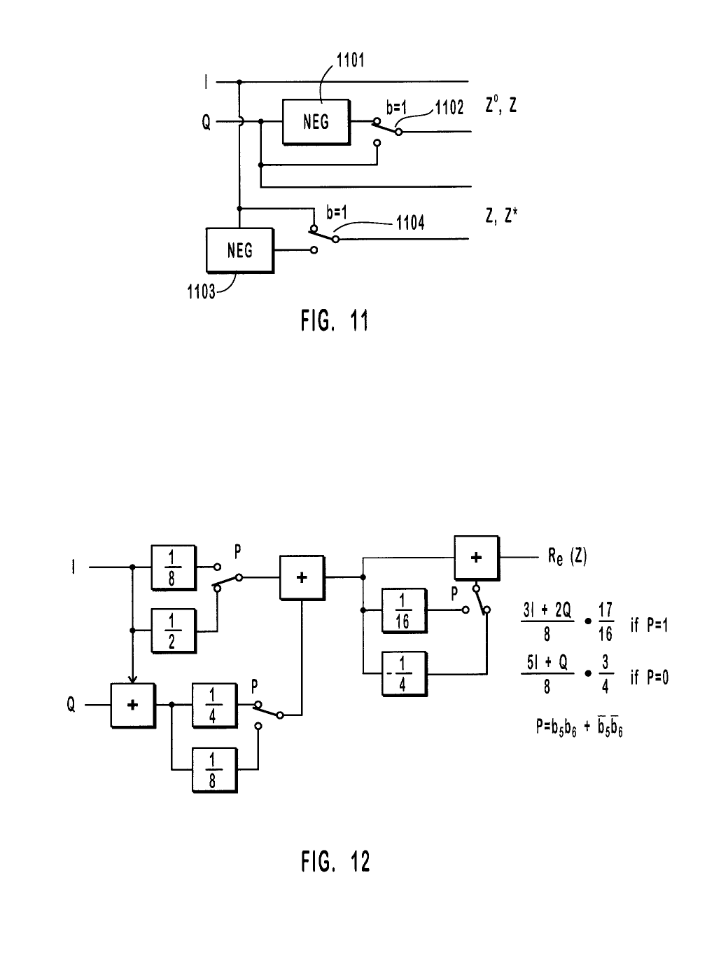

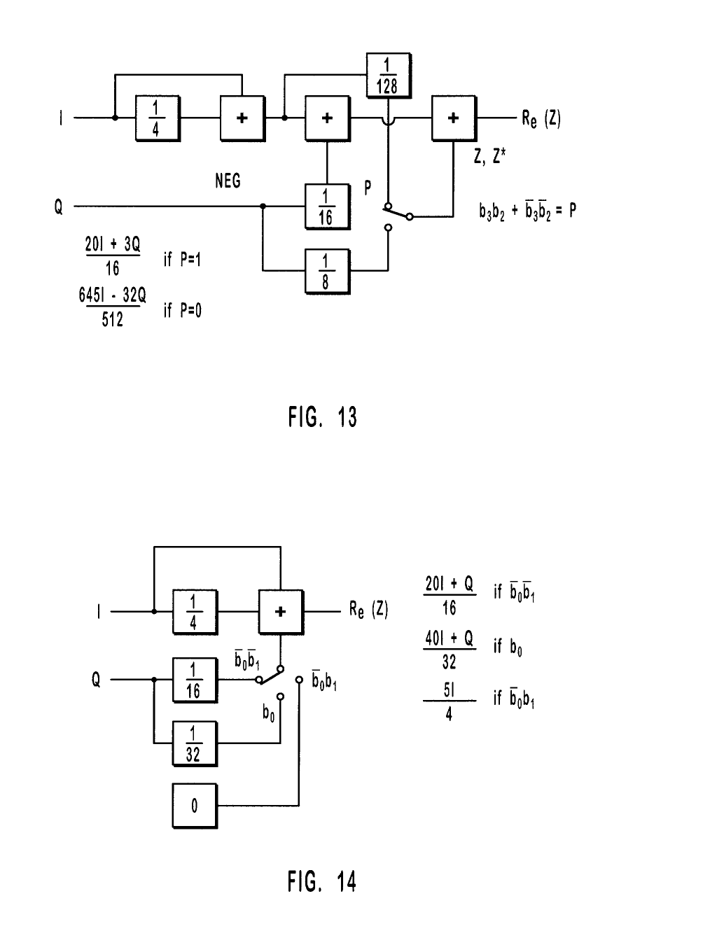

FIG. 10 shows a detailed block diagram of the preferred phase shifter 1000 used in the Baseband to IF Upconverter 209 and the IF to Baseband Downconverter 305 of this invention. This phase shifter provides an economical a method of performing a digital phase shift of an integer multiple of 1/256 of a revolution. This design uses sixteen adders, but does not require a table look up as does some prior techniques. It is also 4 to 5 times more accurate than prior techniques if the exact phase shift required is the 8 bit command. An FFT operation, as used in this invention, requires an exact phase shift defined by an 8 bit command. Therefore, this phase shifter is ideally suited for this system. This phase shifter employs a cascade of four 4-phase shifters 1001, 1003, 1004, 1006, 1007, 1009, 1010, each covering ¼ of the range of the previous shifter. Implementation economies are enhanced by using plus or minus rotations. This requires a bias of 32 1011 be added to the phase command. A command of zero phase is thus implemented as a 32 to the shifter yielding phase shifts of 0, 11.31, −8.53 and 2.86 or 0.08 degrees. The first stage 1001 uses switches to perform rotations of 0, 90, 180 or 270 degrees. The remaining stages uses sense inverters 1002, 1005, 1008 and shifters 1003, 1004, 1006, 1007, 1009, 1010 to implement one of two rotations. The rotations are either plus or minus depending on the inverter output. These rotation circuits have been designed to give precision rotations with a very low gate count. Detail on the sense inverters is shown in FIG. 11. Detail on the second stage shifters 1003, 1004 are shown in FIG. 12. Detail on the third stage shifters 1006, 1007 are shown in FIG. 13. Detail on the fourth stage shifters 1009, 1010 are shown in FIG. 14. In alternative embodiments of this invention, additional stages can be added in a manner similar to the final stage 1009, 1010, with the Q divided by increasing powers of two. The final stage is unique in that the rotations are biased by minus half the smallest command so the total rotation is an integer multiple of 1/256.

FIG. 11 is a detailed schematic of the preferred sense inverter 1002, 1005, 1008 of the phase shifter 1000 of this invention. In this sense inverter both the I and Q inputs are connected both to a straight through path and an inverter (NEG) 1101, 1103. Switches 1102, 1104 are provided to switch the inverted and non-inverted paths.

FIG. 12 is a detailed schematic of the preferred first real shift 33.7, 11.3 1003, 1004 of the phase shifter 1000 of this invention. This shifter is controlled by control signals b5 and b6, which selects between the two shifts, 33.7 or 11.3 degrees. Inputs I and Q are combined as shown in the diagram and equations to give the desired shifts.

FIG. 13 is a detailed schematic of the preferred second real shift 8.53, 2.84 1006, 1007 of the phase shifter 1000 of this invention. This shifter is controlled by control signals b2 and b3, which selects between the two shifts 8.53 or 2.84 degrees. Inputs I and Q are combined as shown in the diagram and equations to give the desired shifts.

FIG. 14 is a detailed schematic of the preferred third real shift 2.84, 1.43, 0 1009, 1010 of the phase shifter 1000 of this invention. This shifter is controlled by control signals b0 and b1, which selects between the three shifts 2.84, 1.43 and 0 degrees. Inputs I and Q are combined as shown in the diagram and equations to give the desired shifts.

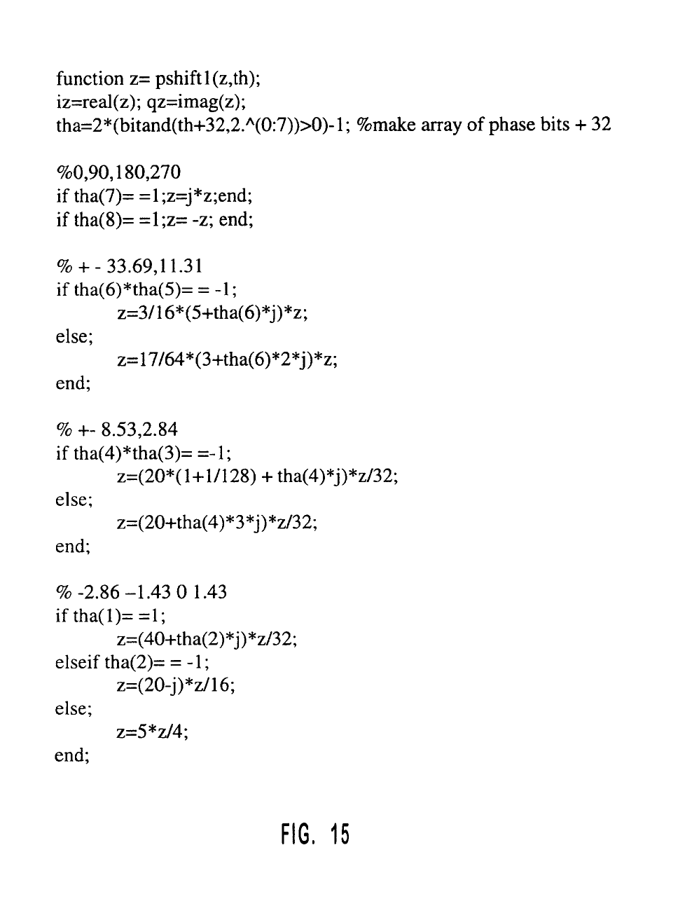

FIG. 15 is a listing of a computer model of the preferred phase shifter 1000 of this invention.

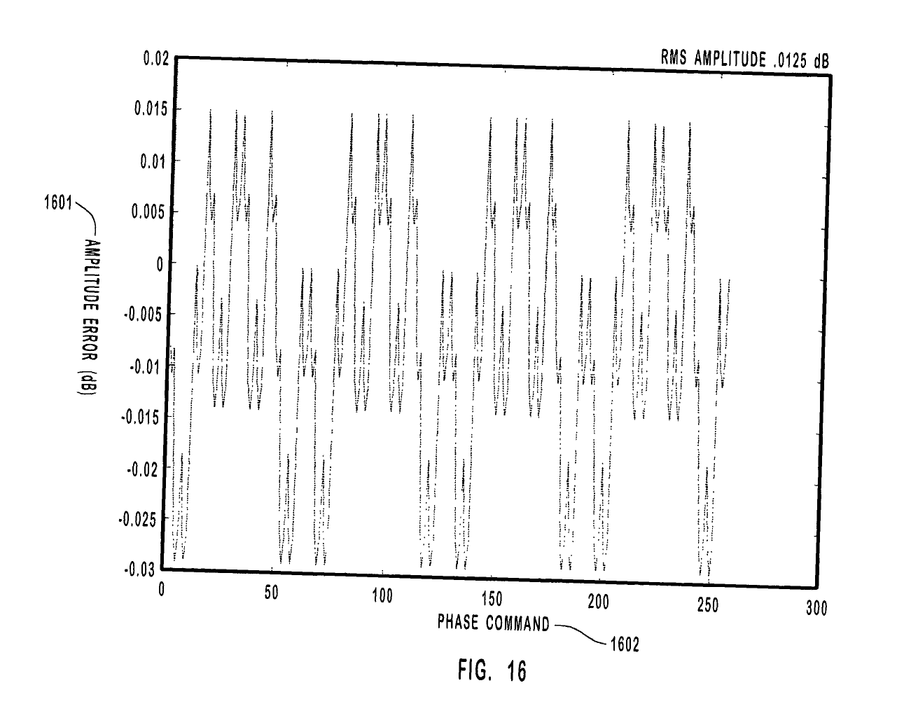

FIG. 16 is a plot of the amplitude error vs the phase command of the preferred phase shifter 1000 of this invention. The amplitude error 1601 is shown on the Y-axis and the phase command 1602 is shown on the X-axis.

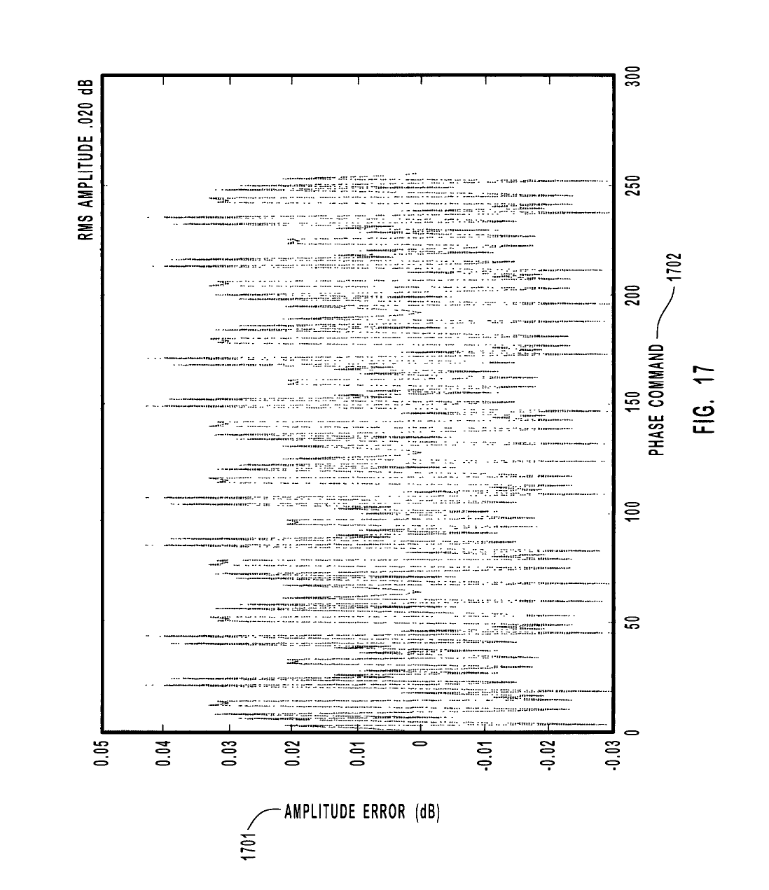

FIG. 17 is a plot of the amplitude error vs phase command of the alternative 8 bit quantized table look up phase shifter. The amplitude error 1701 is shown on the Y-axis and the phase command 1702 is shown on the X-axis.

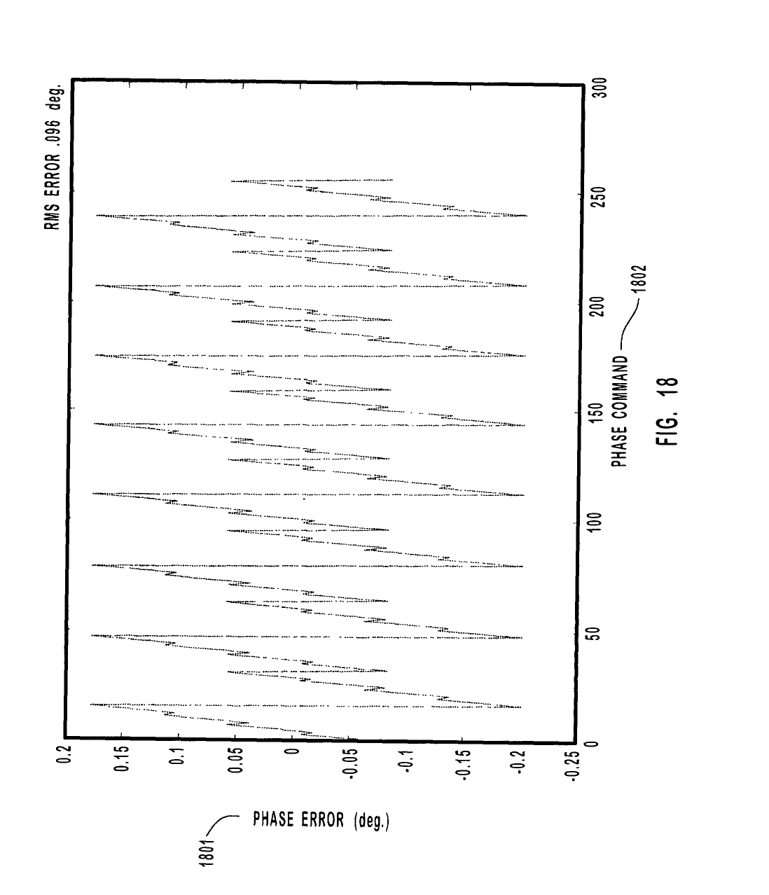

FIG. 18 is a plot of the phase error vs the phase command of the preferred phase shifter 1000 of this invention. The phase error 1801 is shown on the Y-axis and the phase command 1802 is shown on the X-axis.

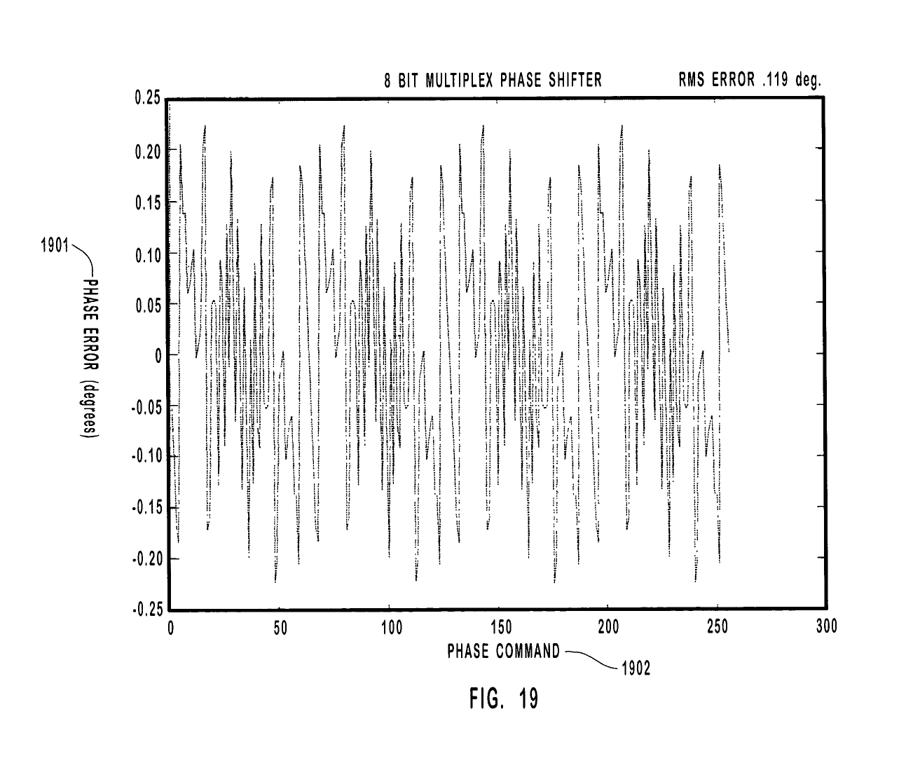

FIG. 19 is a plot of the phase error vs the phase command of the alternative 8 bit quantizied table look up phase shifter The phase error 1901 is shown on the Y-axis and the phase command is shown on the X-axis.

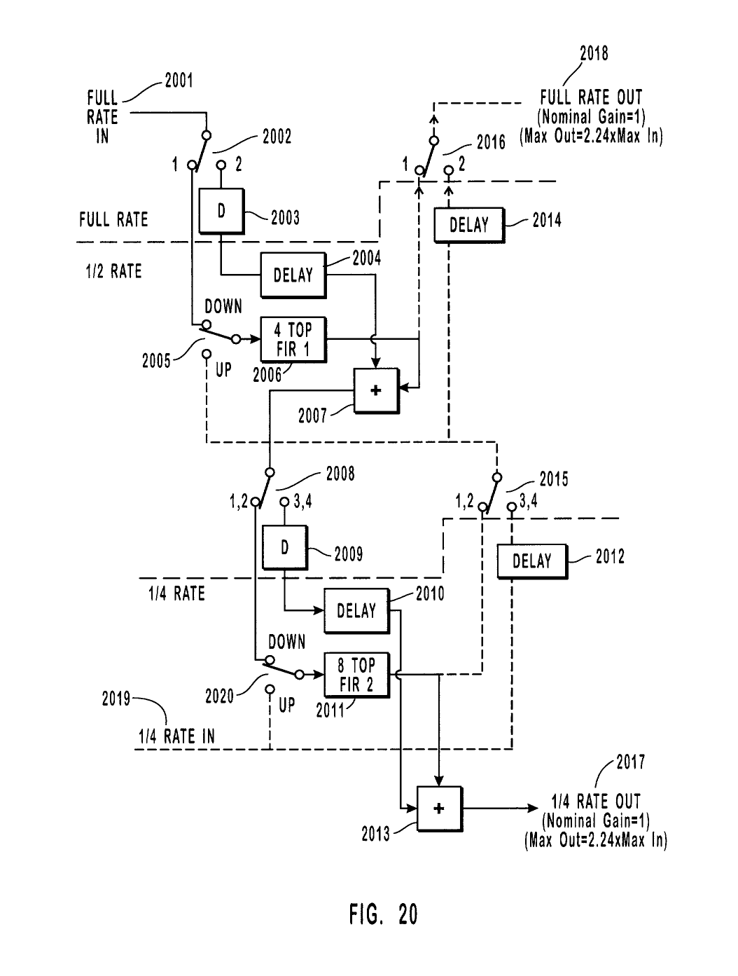

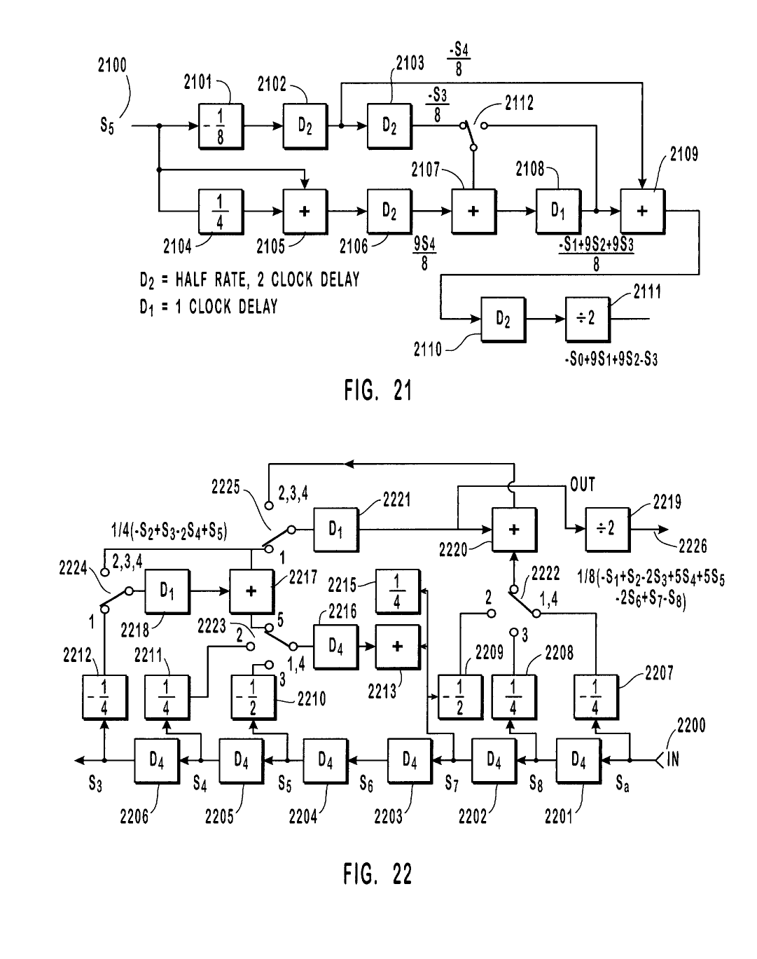

FIG. 20 is a schematic of the preferred quarter band ×4 up/down sampler and filter 208, 305 used in the modulator and demodulator of this invention. The selection between up and down sampling is made at the up/down switches 2005, 2020. The full rate input signal 2001 can be selected either for filtering or only for sampling by setting the switch 2002. A first 2003 and second 2004 delay is provided. The delayed signal is added to the filtered signal output from a four-tap filter 2006. Additional detail on the preferred implementation of the four-tap filter 2006 is provided in FIG. 21. The summed signal from the ADDer 2007 is presented to another switch 2008 for either further delay or additional filtering. A third 2009 and fourth 2010 delay is provided. The delayed signal is added to the output from an eight-tap filter 2011. Additional detail on the preferred implementation of the eight-tap filter 2011 is provided in FIG. 22. A summed signal from the ADDer 2013 is presented as the ¼ rate out 2017. The up sample circuit is shown in this figure as the dashed lines, with the full rate output 2018 the result of the up sample. The full rate output 2018 is a result of the selection 2016 of either the output of the four-tap filter 2006 or a delayed 2014 version of either the full rate in 2001, a delayed version of the Orate in 2019, or a the output of the eight-tap filter 2011.

FIG. 21 is a detailed schematic of a preferred half rate filter 2006 of this invention. The input signal 2100 is received by a ⅛ divider 2101 the output of which is delayed by a 2-clock delay 2102, the output of which is both delayed by a further 2-clock delay 2103 and provided to an adder 2109. The output of the further 2-clock delay 2103 is provided to a switch 2112. The input signal 2100 is also connected to a ¼ divider 2104, the output of which is connected to an Adder 2105. The other input to the Adder 2105 is also the input signal 2100. The output of Adder 2105 is delayed by a 2-clock delay 21 06. This 2-clock delay 2106 output is connected to the Adder 2107, the output of which is connected to a 1-clock delay 2108. The output of the 1-clock delay 2108 is presented to adder 2109. The output of the adder 2109 is connected to a 2-clock delay 2110, the output of which is connected to a divide-by-two 2111. The output of the divide-by-two 2111 is the output of the 4-tap filter.

FIG. 22 is a detailed schematic of a preferred quarter rate filter 2011 of this invention. The input signal 2200, is provided to a 14/divider 2207 and a first 4-clock delay 2201. The output of the first 4-clock delay 2201 is connected to a ¼divider 2208 and to a second 4-clock delay 2202. The output of the second 4-clock delay 2202 is connected to a ½ divider 2209 and to a third 4-clock delay 2203. The output of the third 4-clock delay 2203 is connected to a fourth 4-clock delay 2204. The output of the fourth 4-clock delay 2204 is connected to a ½ divider 2210 and a fifth 4-clock delay 2205. The output of the fifth 4-clock delay 2205 is connected to a ¼ divider 2211 and a sixth 4-clock delay 2206. The output of the sixth 4-clock delay 2206 is a ¼ divider 2212. The output of the first ¼ divider 2207 is connected to a switch 2222, as are the outputs of the first ¼ divider 2208 and the first ½ divider 2209. The output of the second ½ divider 2210 is connected to a switch 2223, as are the outputs of the second 4 divider 2211. The output of the second ¼ divider 2212 is connected to a switch 2224. Switch 2224 is connected to a first 1-clock delay 2218 and to another switch 2225. The output of the first 1-clock delay 2218 is connected to an Adder 2217, the other input of which is connected to switch 2223. The output of Adder 2217 is connected to the switch 2225, the output of which is connected to a 1-clock delay 2221. The output of the 1-clock delay 2221 is connected to an Adder 2220 and a divide-by-2 2219. The output of the Adder 2220 is connected to switch 2225. The output of the second 4-clock delay is also connected to an Adder 2213 and another ¼ divider 2215, the output of which is the other input to Adder 2213. The output of Adder 2213 is connected to a seventh 4-clock delay 2216. The output of the seventh 4-clock delay 2216 is connected to the switch 2223.

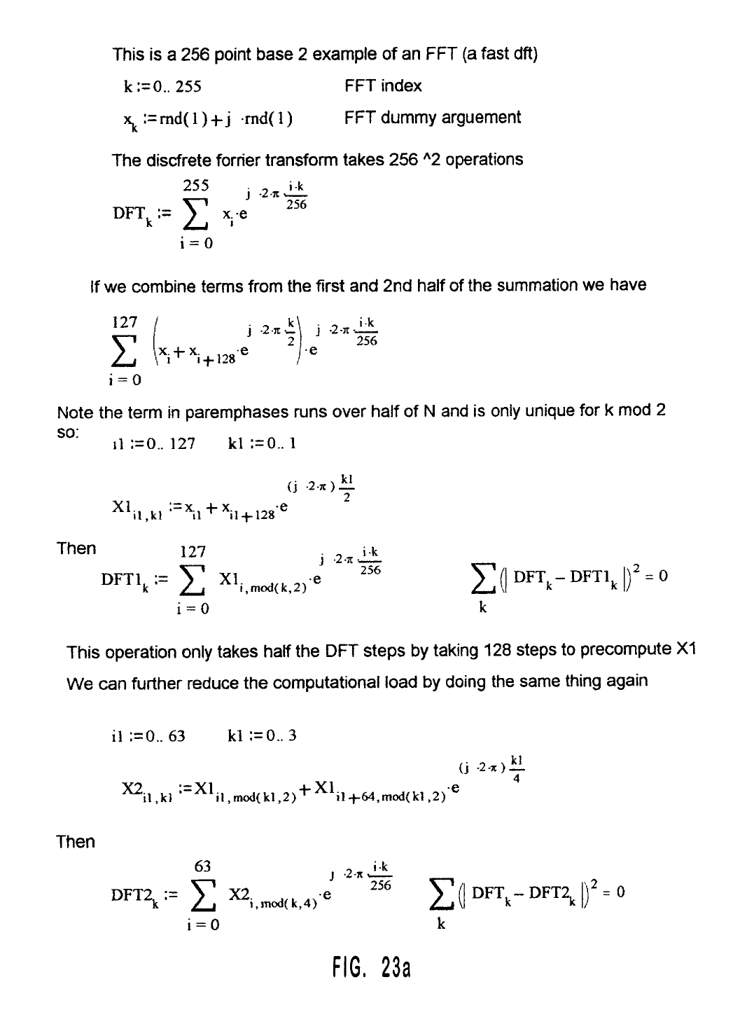

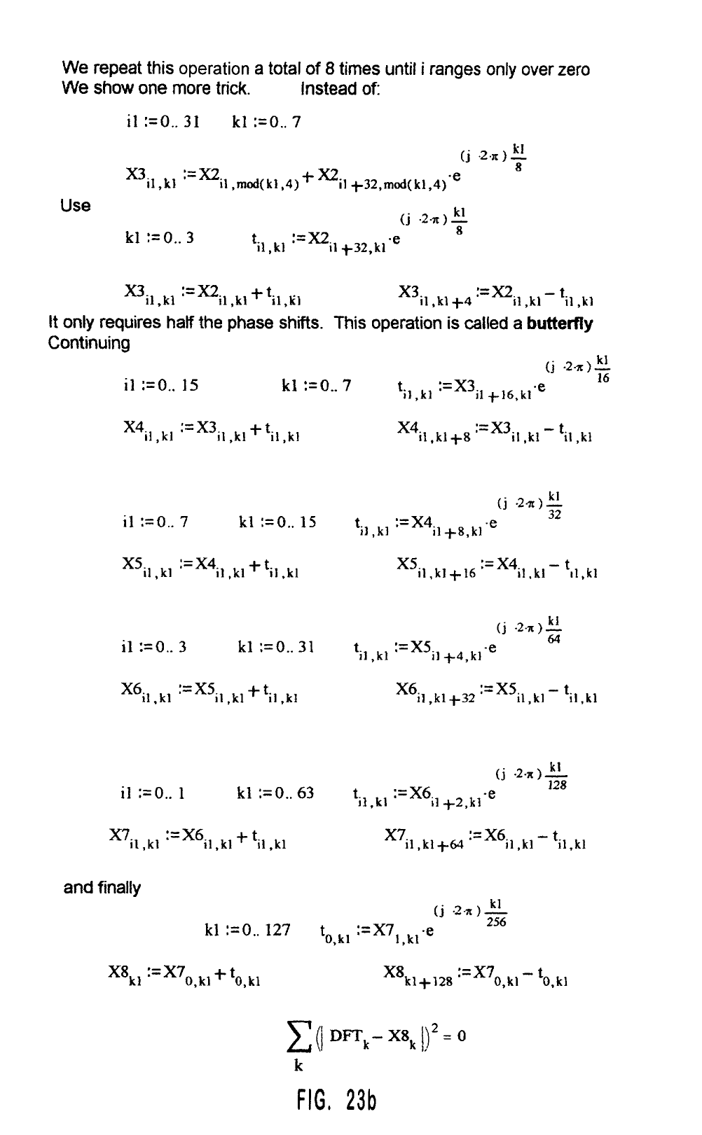

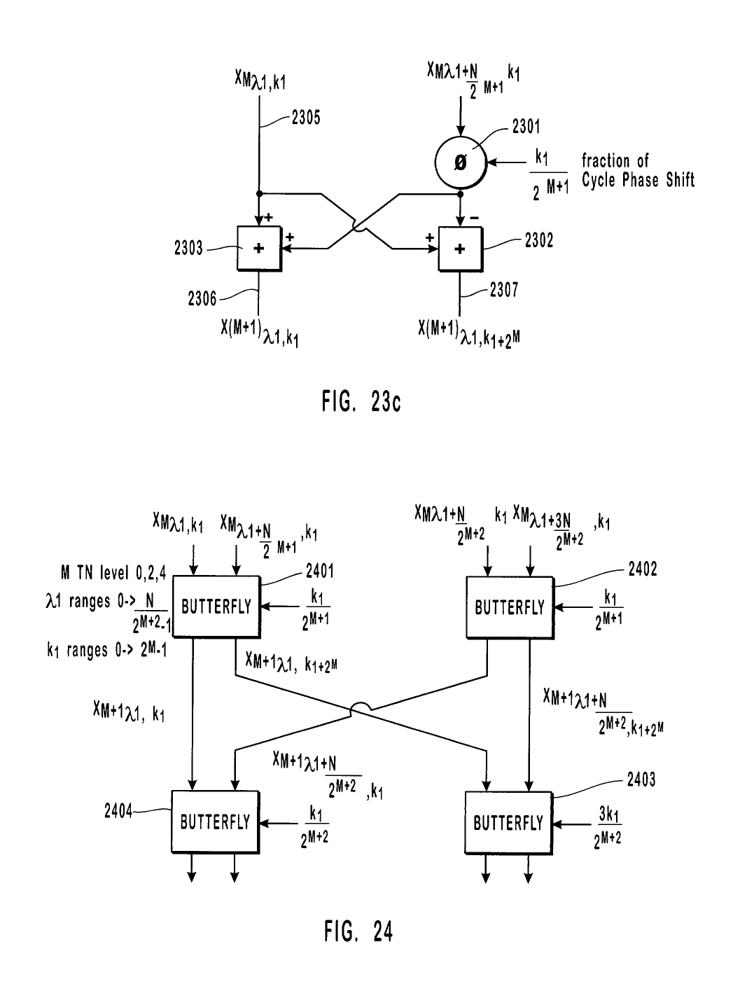

A Fast Fourier Transformer (FFT) is a computationally efficient method of performing a discrete Fourier transform. A mathematical derivation of the FFT in base 2 are shown in FIGS. 23a,b.

FIG. 23c is a detailed schematic of a Butterfly circuit of a FFT. A Butterfly FFT consists of a phase shifter 2301 and two Adders 2302, 2303 of complex numbers. The phase shift 2301 can be done with a digital phase shifter, like a Digitac or with four real multipliers and a phase shifter to complex magnitude mapping. A FFT requires N/2 log(N) Butterfly operations where N is the number of points in the transform and is a power of 2. For continuously operating FFT″s the transform is performed every time N samples are collected. If one Butterfly can be performed on each sample clock then at leas log(N)/2 Butterflies are required. Thus for a 256 point FFT four Butterflies are needed, as shown in FIG. 24. If more clocks are available per sample collection the number of Butterflies can be reduced. For example, if a system uses 420 sample clocks between FFT″s and there are three Butterfly clocks per sample clock then there are 1260 Butterfly clocks available and a single Butterfly could produce the 1024 required operations.

FIG. 24 is a detailed schematic of a dragonfly circuit of a FFT using four Butterflies 2401, 2402, 2403, 2404 in 256 sample clocks. This is essentially a base four Butterfly or dragonfly. Two alternative techniques for buffering the intermediate stages are as follows. First, switched input and output single port RAMS are configured so that samples 0, 64, 128, and 192 for a RAM output word with addresses 0 to 63. Samples 0, 1, 2, and 3 form an input word with address increments in steps of 4. The second technique uses a single multiport RAM. On the first pass inputs and outputs are samples 0, 64, 128 and 192 incremented by 1 up to 64. On the second pass addresses 0, 16, 32, and 48 are incremented by 1 up to 15 then by 65 to 128, repeating the 1 increments than another 65 until all RAM is processed. On a third pass is to 0, 4, 8, 12 incremented by 1 ten 16 and the fourth pass is to 0, 1, 2, 3 and is incremented by 4. For OFDM the time samples are real. FFT″s can be done two at a time by multiplying one by j and by forcing conjugate symmetry for the real part. Two sample collection times are then used to perform the FFT. Real data is down converted about its center frequency to a complex baseband, properly filtered and the half rate is sampled to produce a half size transform. In one preferred embodiment, the downconversion and filtering is done digitally and is down sampled.

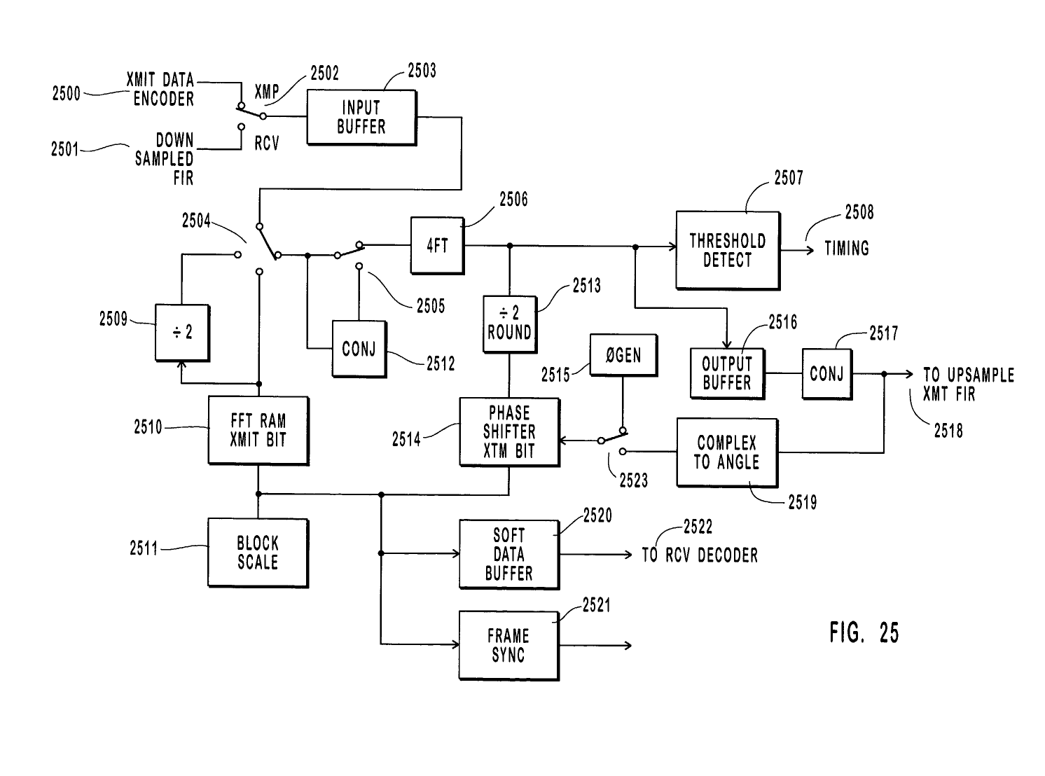

FIG. 25 is a detailed schematic of an FFT, acquisition and time differential demodulator 306 of this invention. The transmitted data from the encoder 2500 is connected to a switch 2502. The other input of the switch 2502 is receive data from the downsampled FIR 2501. The output of the switch 2502 is connected to an input buffer 2503. The output of the input buffer 2503 is connected to a second switch 2504. The output of the second switch 2504 is connected to a third switch 2505. The output of the third switch 2505 is connected to a 4FT circuit. The other input to the third switch 2505 is a Conjugate circuit 2512, whose input is also the output of the second switch 2504. The output of the 4FT circuit 2506 is connected to a threshold detector 2507, an output buffer 2516, and a divide-by-2 and round circuit 2513. The output of the divide-by-2 and round circuit 2513 is a phase shifter 2514. The output of the phase shifter 2514 is connected to a frame synchronizer 2521, a soft data buffer 2520, a block scale 2511, and a FFT RAM 2510. The output of the FFT Ram is connected to a divide-by-2 circuit 2509 as well as to an input of the second switch 2504. The output of the divide-by-2 circuit 2509 is also connected to an input of the second switch 2504. The output of the soft data buffer 2520 is connected 2522 to the receive decoder. The threshold detector 2507 provides a timing signal 2508 for its output. The output of the output buffer 2516 is connected to second conjugator 2517. The output of the second conjugator 2517 provides a signal 2518 to the upsample transmitter as well as to the input of a complex to angle circuit 2519. The output of the complex to angle circuit 2519 is an input to a fourth switch 2523. The other input to the fourth switch 2523 is from a phase generator 2515. The output of the fourth switch 2523 is a phase input to the phase shifter 2514.

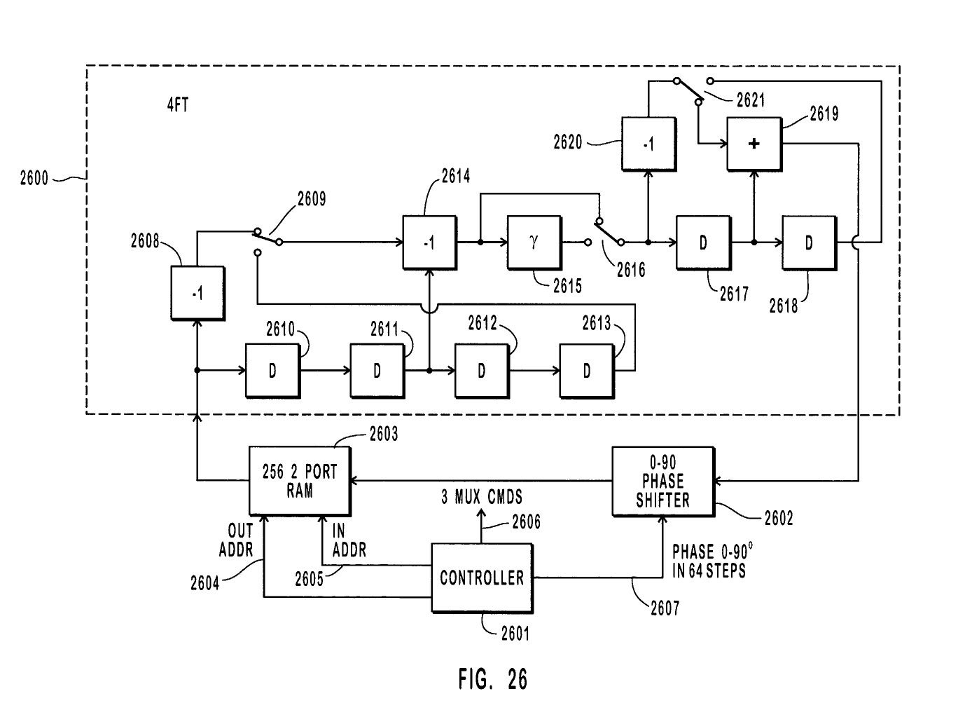

FIG. 26 is a detailed schematic of a preferred dragon fly circuit of the FFT of this invention. This dragon fly circuit employs four passes through 256 points, with 64 4FT″s (Fourier Transforms) per pass, four clocks per 4FT and 1024 clocks per transform. A controller 2601 provides signals to three multiplexer cards, control to a 0-90 degree phase shifter 2602, which preferably shifts the signal phase in 64 step increments, and to the In and Out address lines of the 256 k 2 Port RAM. The 0-90 degree phase shifter 2602 receives data from the 4FT circuit 2600. The output of the 256 k 2 Port RAM provides the data signal input to the 4FT circuit 2600. The received signal form the 256 k 2 Port RAM is received by a first one clock delay 2610 and a second delay circuit 2608. The output of the second delay circuit 2608 is connected to a first input of the a first switch 2609. The output of the first switch 2609 is connected to a third one clock delay 2614, the output of which is connected to a gamma circuit 2615 and a second switch 2616. The output of the gamma circuit 2615 is also connected to another input of the second switch 2616. The output of the second switch 2616 is a connected to a fourth one clock delay 2620 and a fifth delay 2617. The output of the fifth delay 2617 is connected to an adder 2619 and a sixth delay 2618. The output of the sixth delay 2618 is connected to a third switch 2621. The other input to the third switch 2621 is the output of the fourth one clock delay 2620. The output of the third switch 2621 is connected to the other input of the adder 2619. The output of the adder 2619 is the signal which is input to the 0-90 degree phase shifter 2602. The output of the first clock delay 2610 is connected to a sixth delay 2611. The output of the sixth delay 2611 is connected both to the third one clock delay 2614 and to a seventh delay 2612. The output of the seventh delay 2612 is connected to a eighth delay 2613. The eighth delay 2613 output is connected to the second input to the first switch 2609.

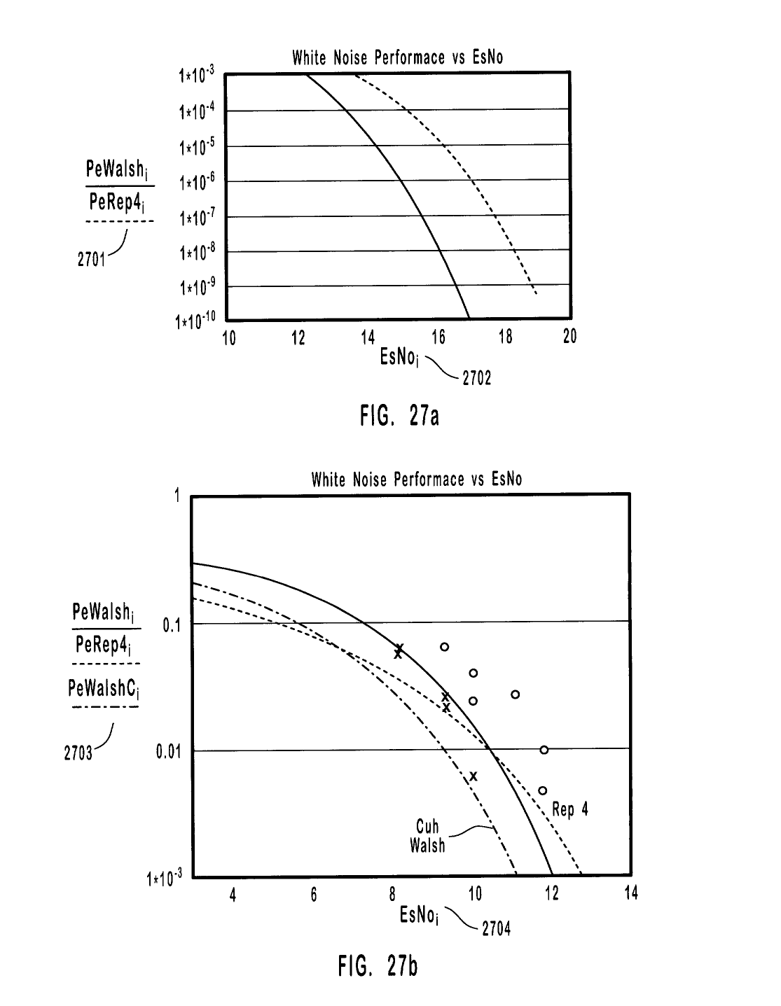

FIGS. 27a,b are plots showing the white noise performance of a Walsh Encoder vs a repeat 4 White Gaussian code. The white noise performance 2710 is shown on the Y-axis of FIG. 27a, while EsNo 2702 is shown on the X-axis. White noise performances of the various codes 2703 of FIG. 27b, while EsNo 2704 is shown on the X-axis.

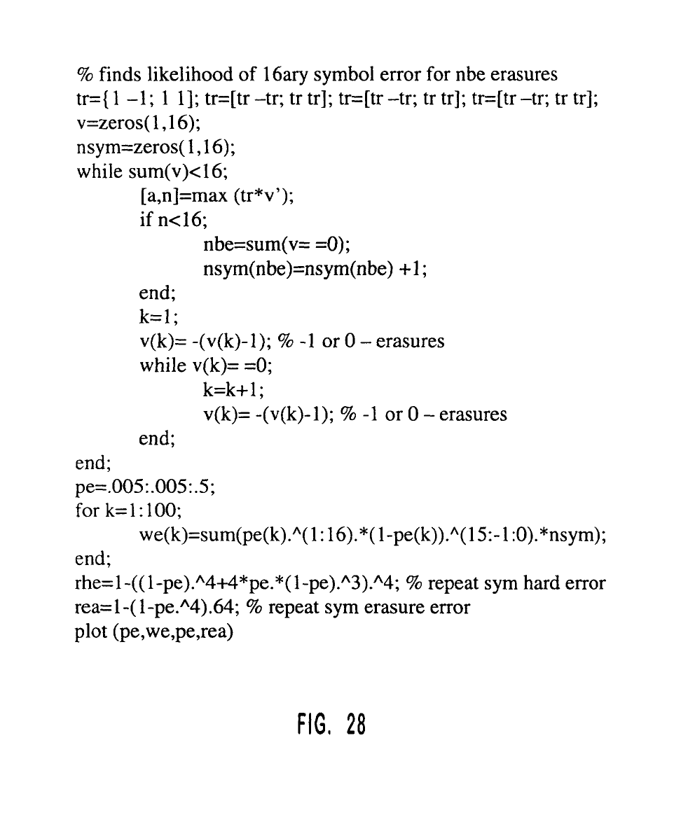

FIG. 28 is a listing of the preferred program code used in the finding the 16ary error for nbe erasures.

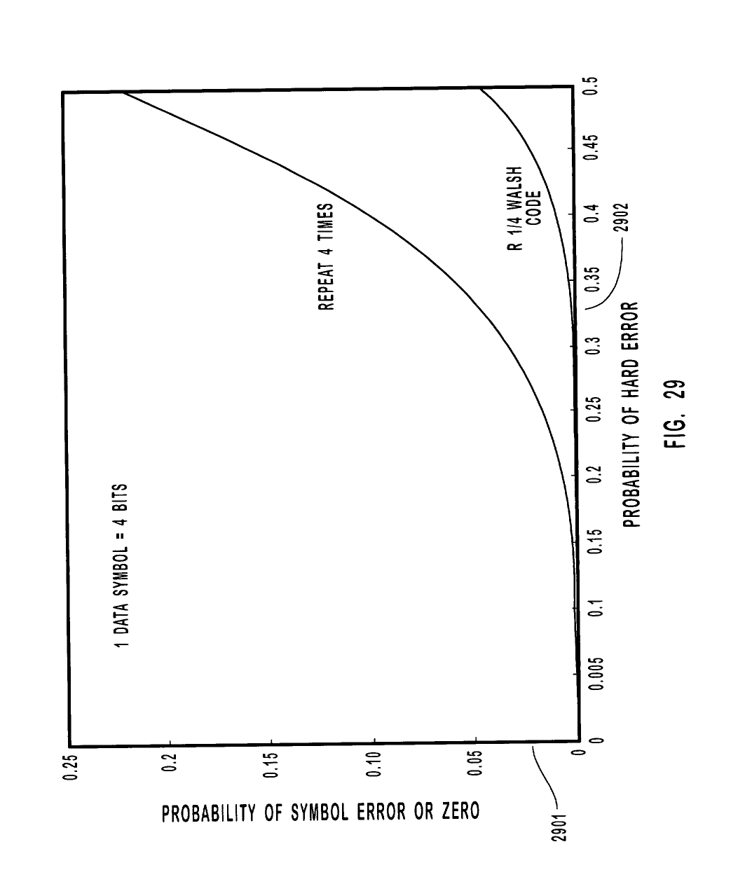

FIG. 29 is a plot of the erasure performance for (16,4) codes. The probability of symbol error 2901 is shown on the Y-axis while the probability of hard error 2902 is shown on the X-axis.

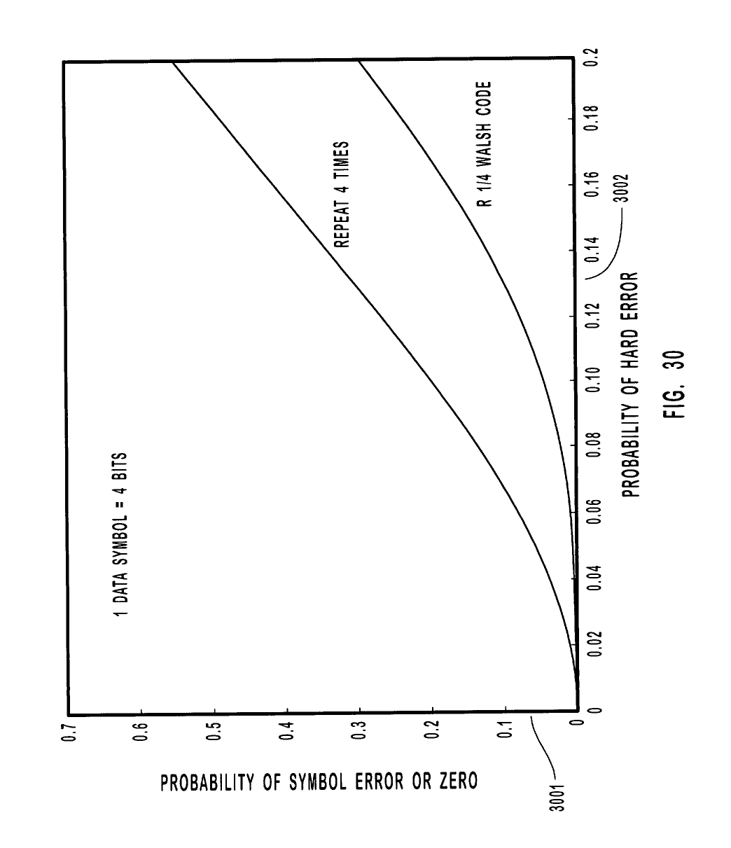

FIG. 30 is a plot of the hard error performance for (16,4) codes. The probability of symbol error 3001 is shown on the Y-axis while the probability of hard error 3002 is shown on the X-axis.

FIG. 31 is a plot of the Walsh coding bit error rate vs SNR for each channel. The error rate 3101 is shown in the Y-axis, while the SNR 3102 is shown in the X-axis.

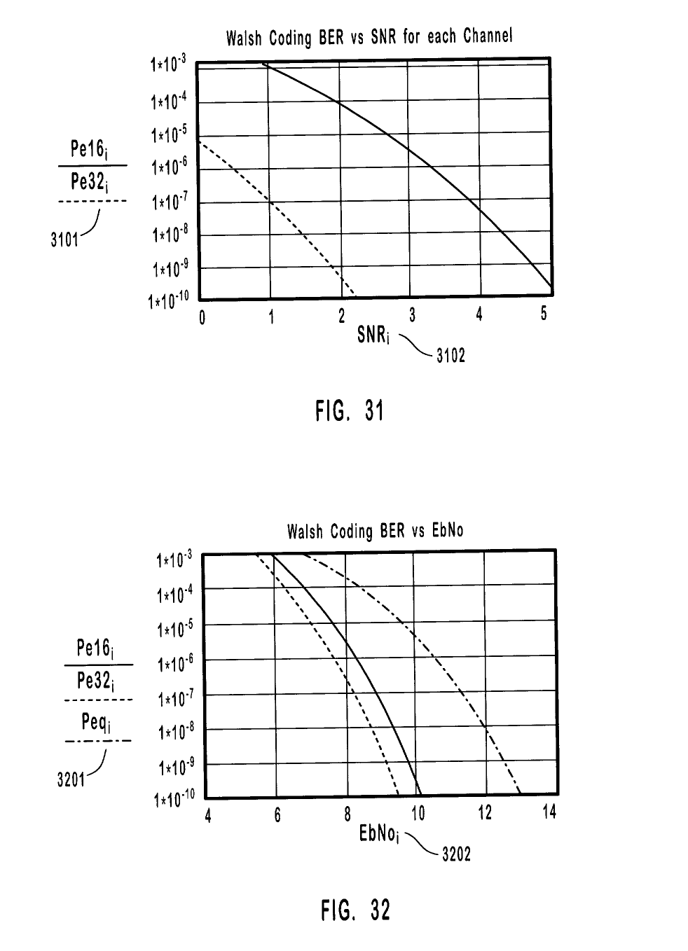

FIG. 32 is a plot of the Walsh coding bit error rate vs EbNo. The error rates 3201 are shown on the Y-axis, while the EbNo 3202 is shown on the X-axis.

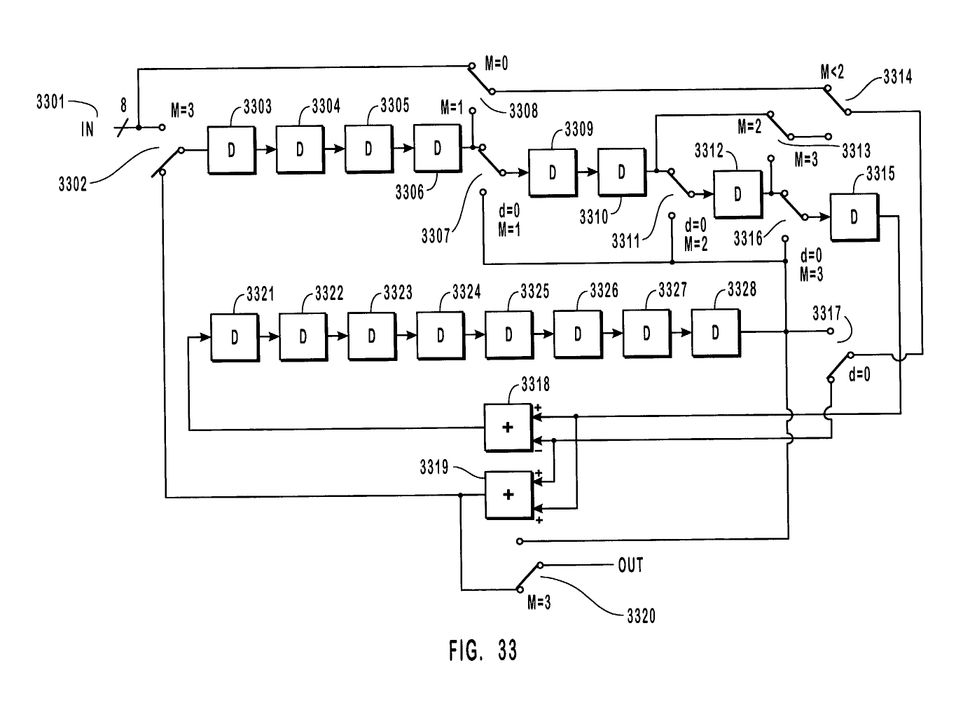

FIG. 33 is a detailed schematic of the preferred fast 16 symbol Walsh decoder preferred in this invention. Data 3301 is input to a first switch 3302 as well as a second switch 3308. The output of the first switch 3302 is received by the input to a first delay 3303. The output of the first delay 3303 is received by the input to a second delay 3304. The output of the second delay 3304 is received by the input to a third delay 3305. The output of the third delay 3305 is received by the input to a fourth delay 3306. The output of the fourth delay 3306 is connected to another input to the second switch 3308 as well as an input to a third switch 3307. The output of the third switch 3307 is connected to a fifth delay 3309. The output of the fifth delay 3309 is connected to an input to a sixth delay 3310. The output of the sixth delay 3310 is connected to a fourth switch 3311. The output of the fourth switch 3311 is connected to a fifth switch 3314, the other input of which is provided by the output of the second switch 3308. The output of the fourth switch 3311. The output of the fourth switch 3311 is connected to a seventh delay 3312. The output of the seventh delay 3312 is connected to a sixth switch 3313 as well as a seventh switch 3316. The output of the sixth switch 3313 is an input to the fifth switch 3314. The output of the seventh switch 3316 is connected to an eighth delay 3315. The output of the fifth switch 3314 is connected to an eighth switch 3317. The outputs of the eighth delay 3315 and the eighth switch 3317 are connected to adders 3318, 3319. The output of the adder 3319 is connected to the second input of the first switch 3302. The output of the second adder 3318 is connected to an input of a ninth delay 3321. The output of the ninth delay 3321 is connected to the input of the tenth delay 3322. The output of the tenth delay 3322 is connected to the input of the eleventh delay 3323. The output of the eleventh delay 3323 is connected to the input of the 12^{th} delay 3324. The output of the 12^{th} delay 3324. The output of the 13^{th} delay 3325 is connected to the 14^{th} delay 3326. The output of the 14^{th} delay 3326 is connected to the 15^{th} delay 3327. The output of the 15^{th} delay 3327 is connected to the 16^{th} delay 3328. The output of the 16^{th} delay 3328 is connected to the second inputs of the third switch 3307, the fourth switch 3311, the seventh switch 3316, the eighth switch 3317, and the ninth switch 3320. The output of adder 3319 is also connected to a ninth switch 3320. The output of the ninth switch 3320 is the output of the encoder.

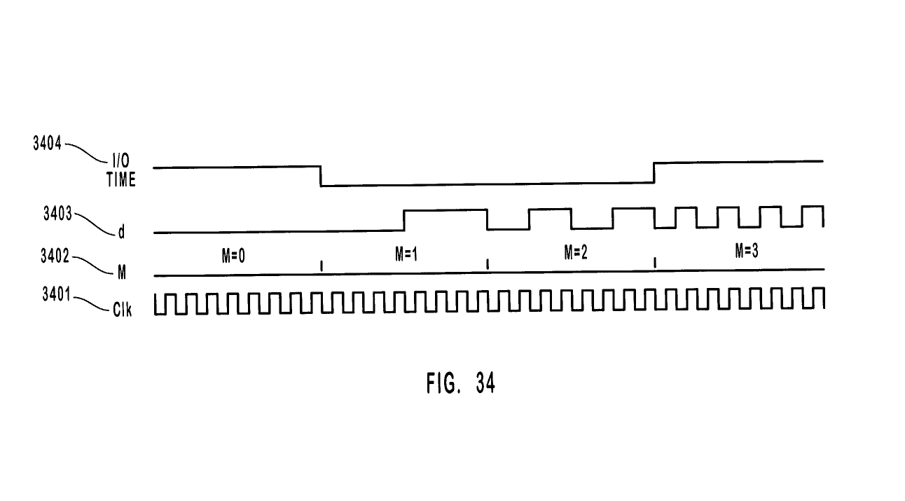

FIG. 34 is a time plot of Walsh encoding, showing a clock 3401, a m-symbol 3402, a d-symbol 3403 and the I/O time 3404.

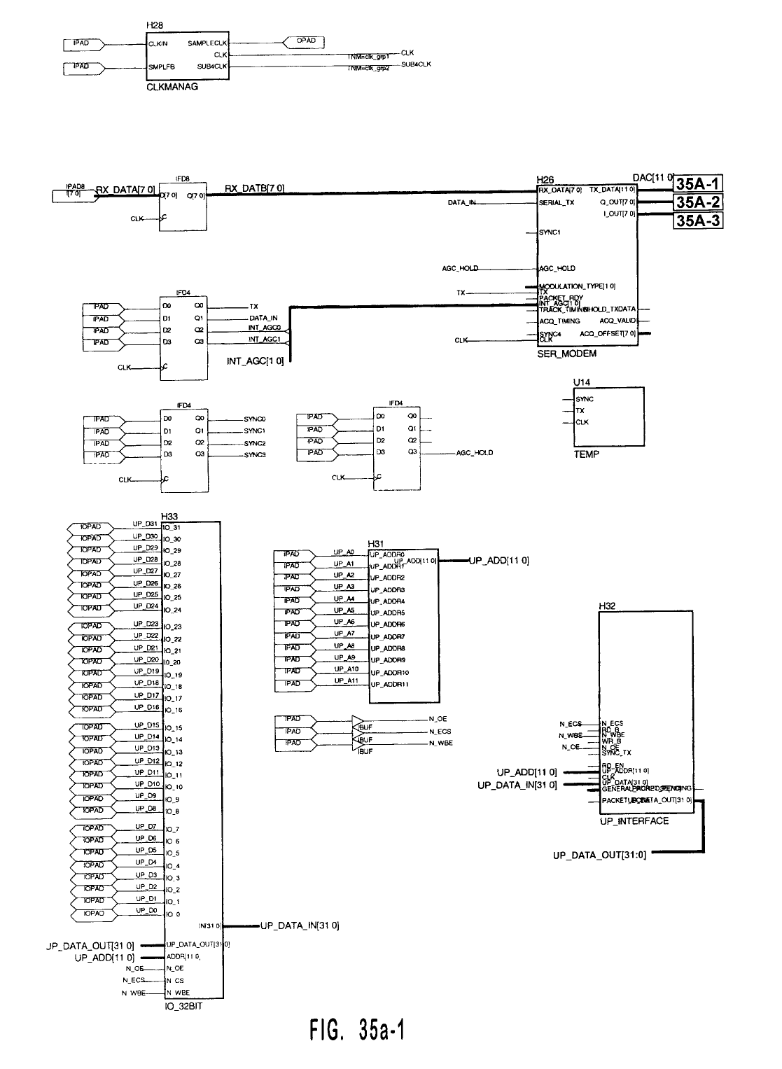

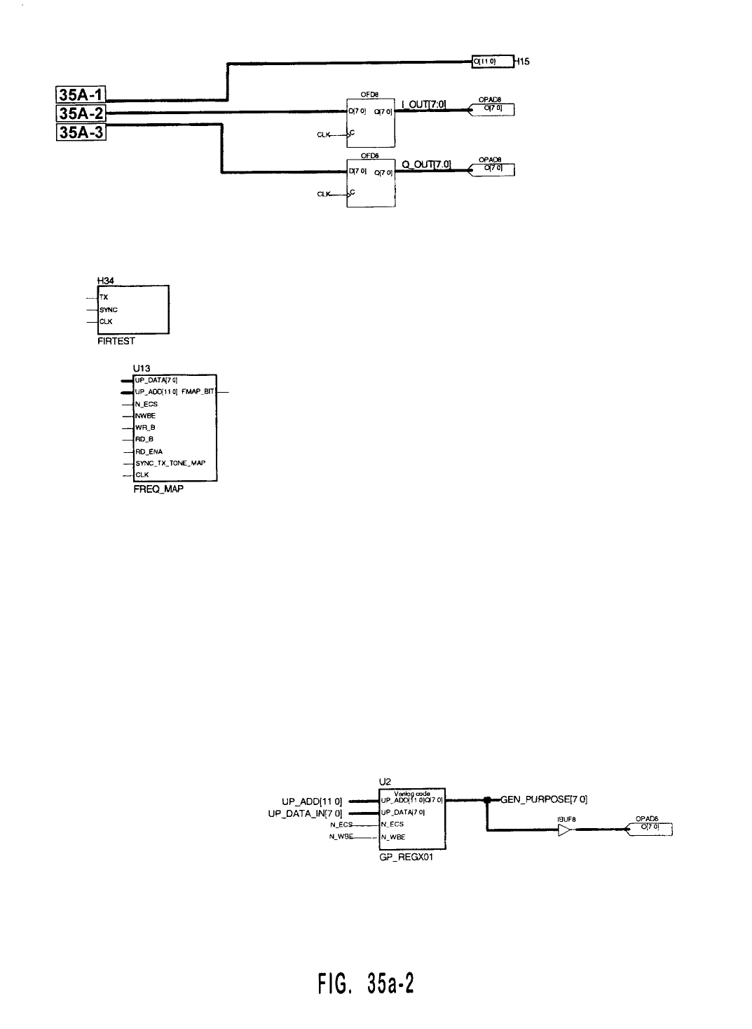

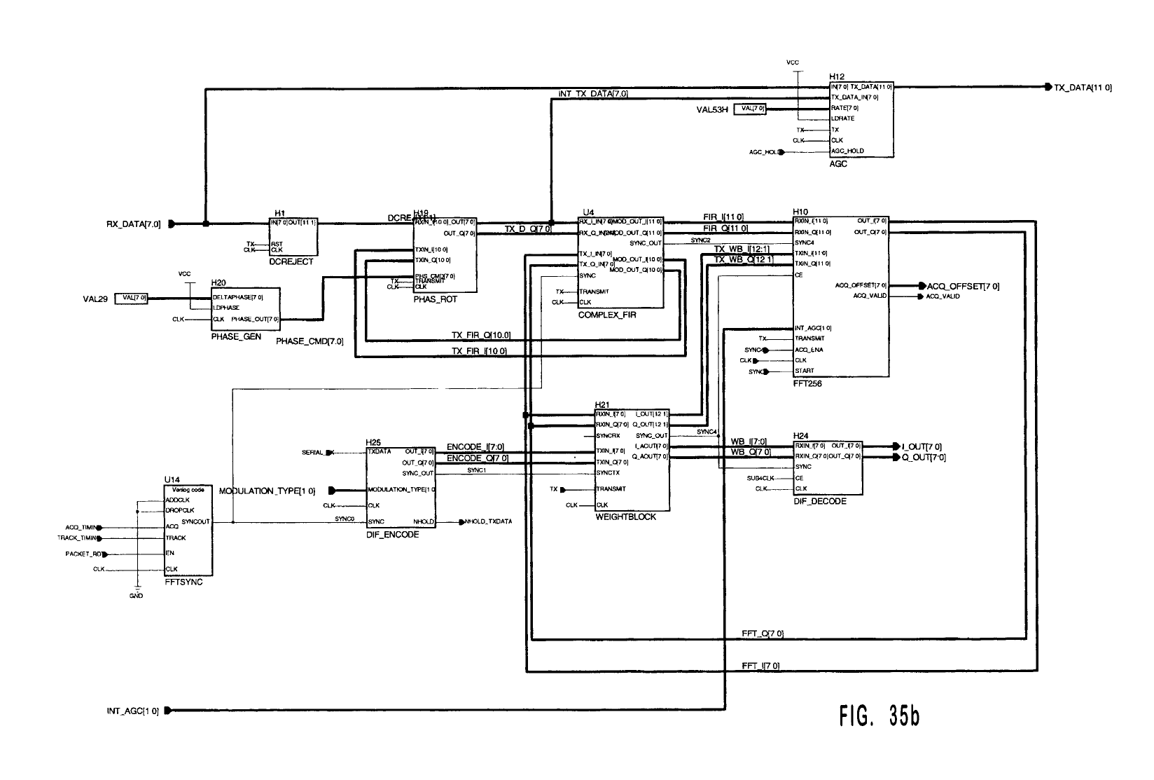

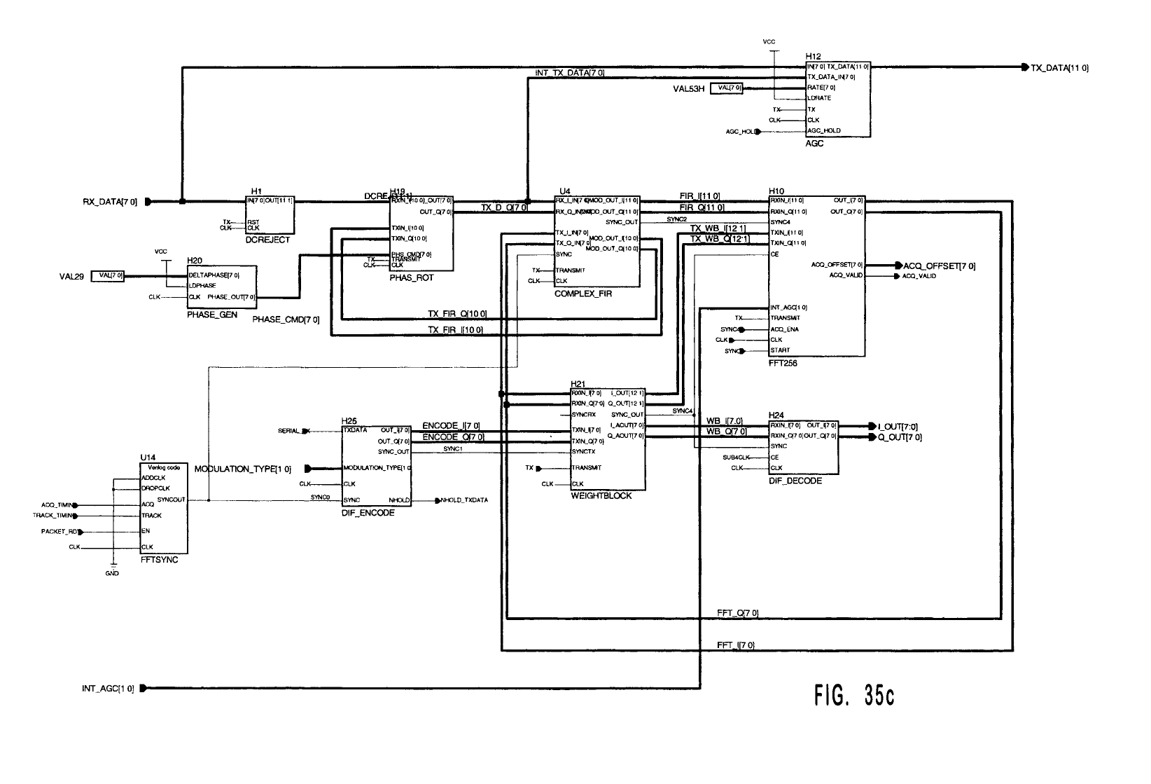

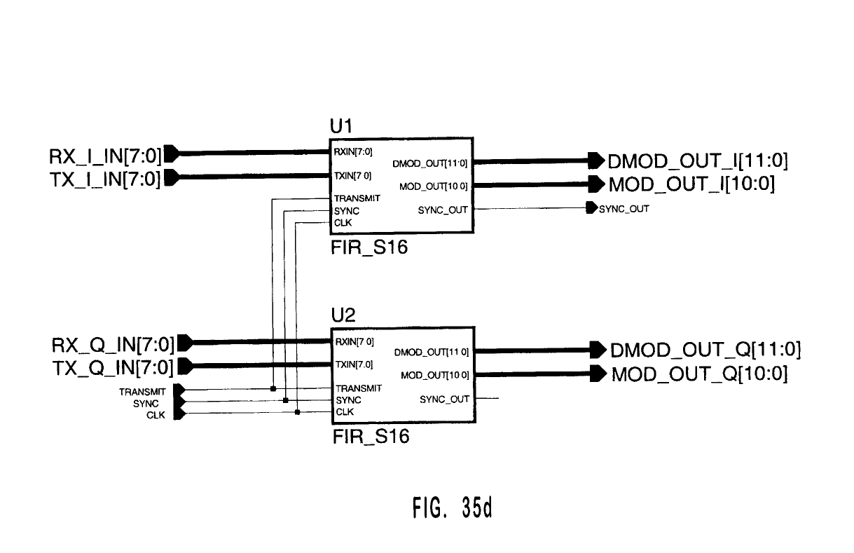

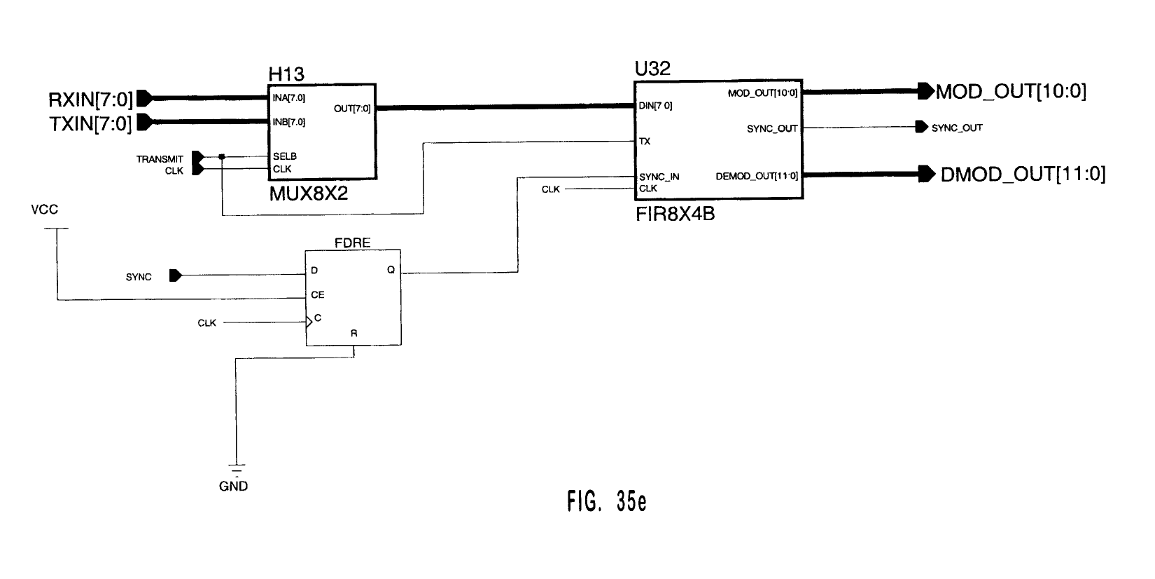

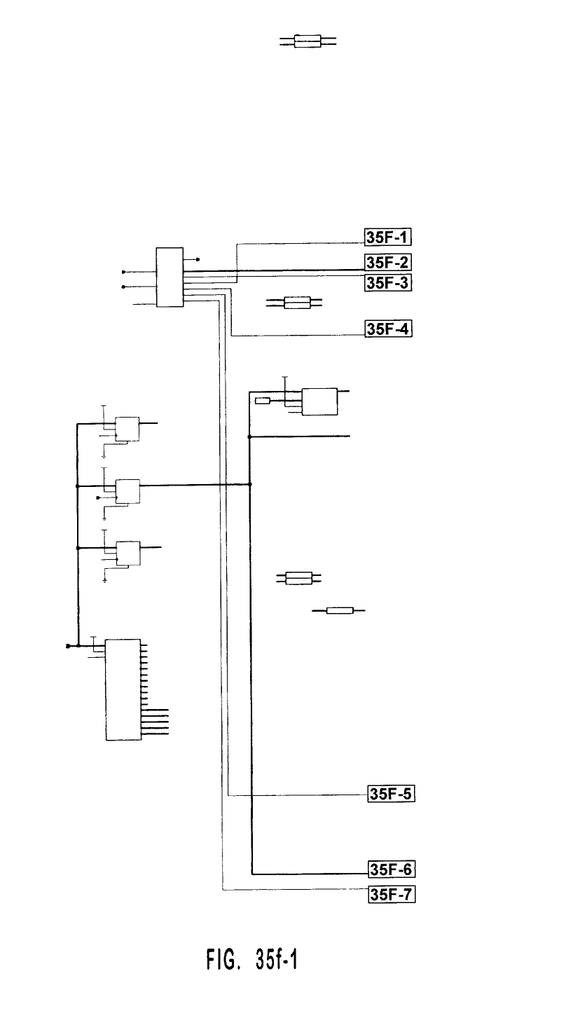

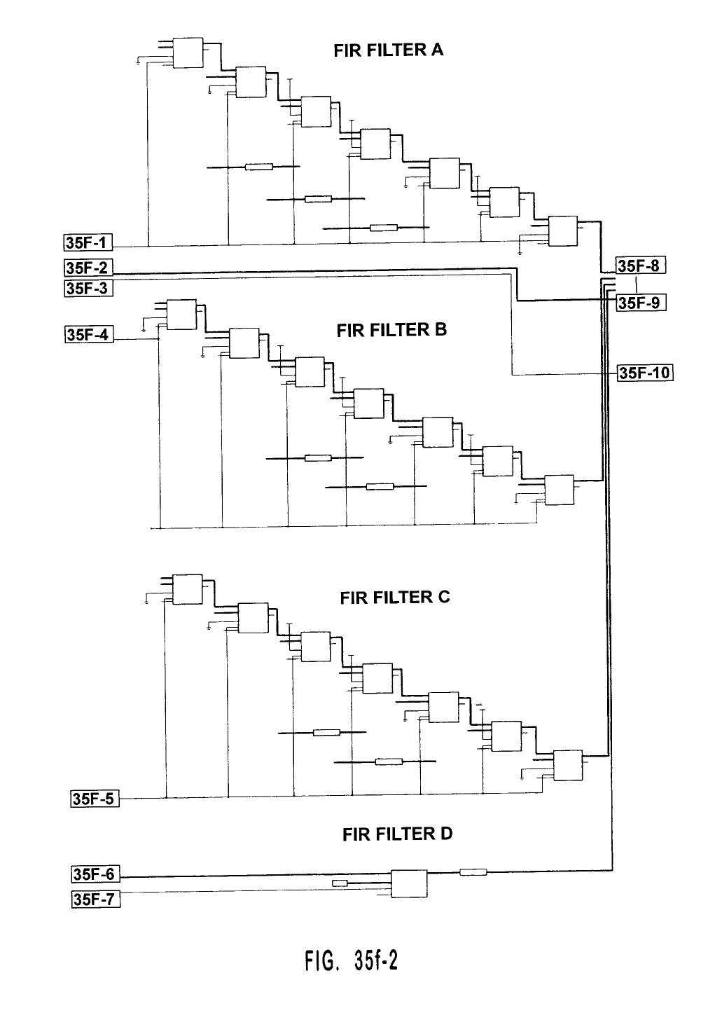

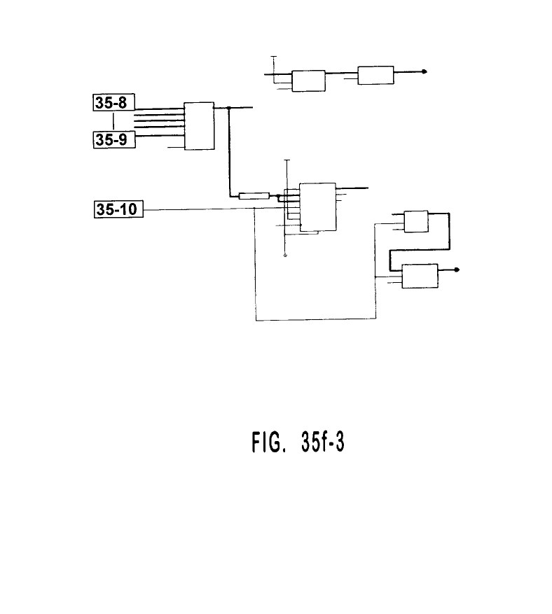

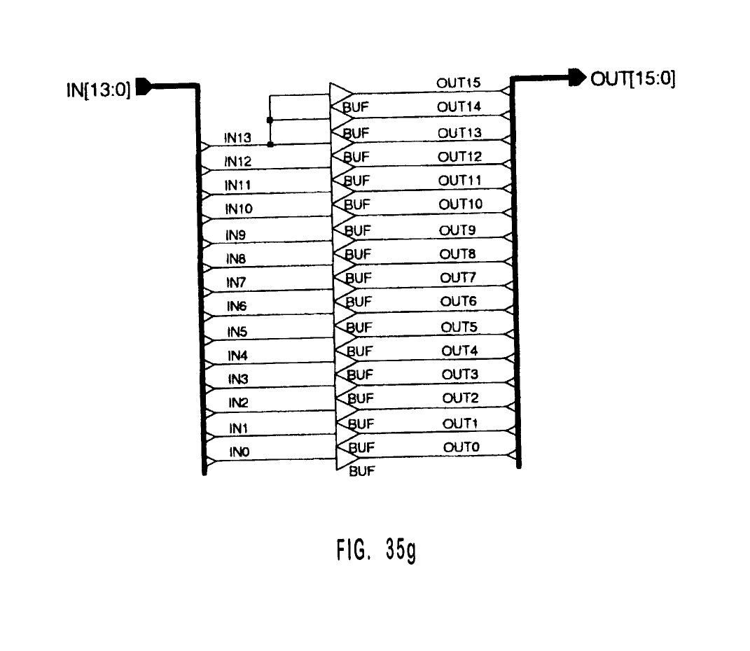

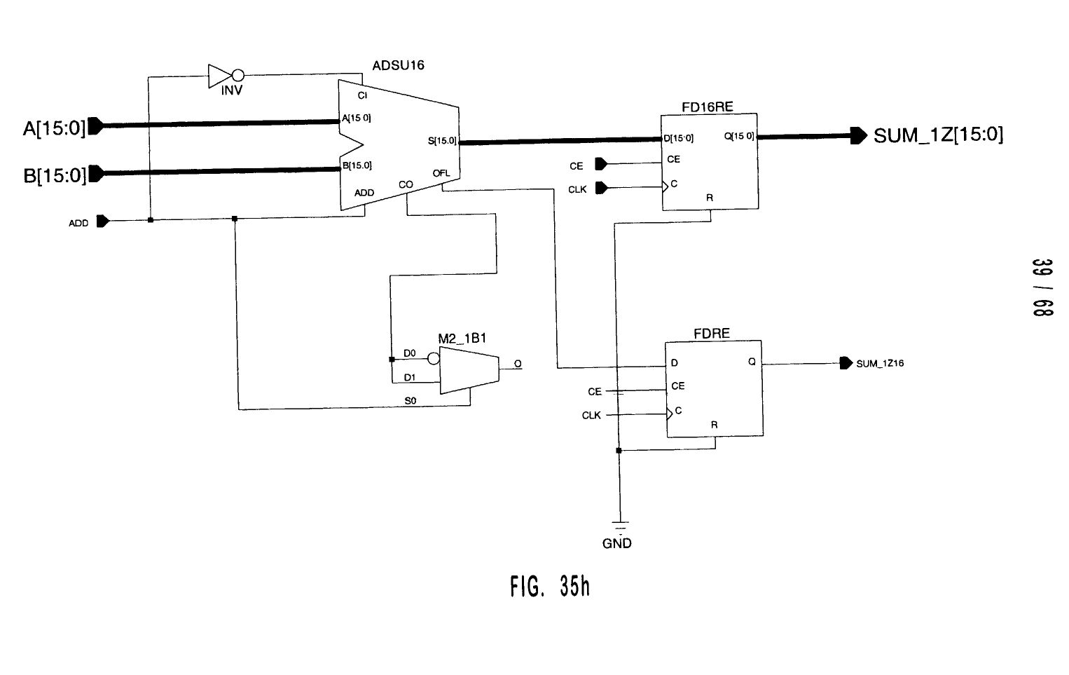

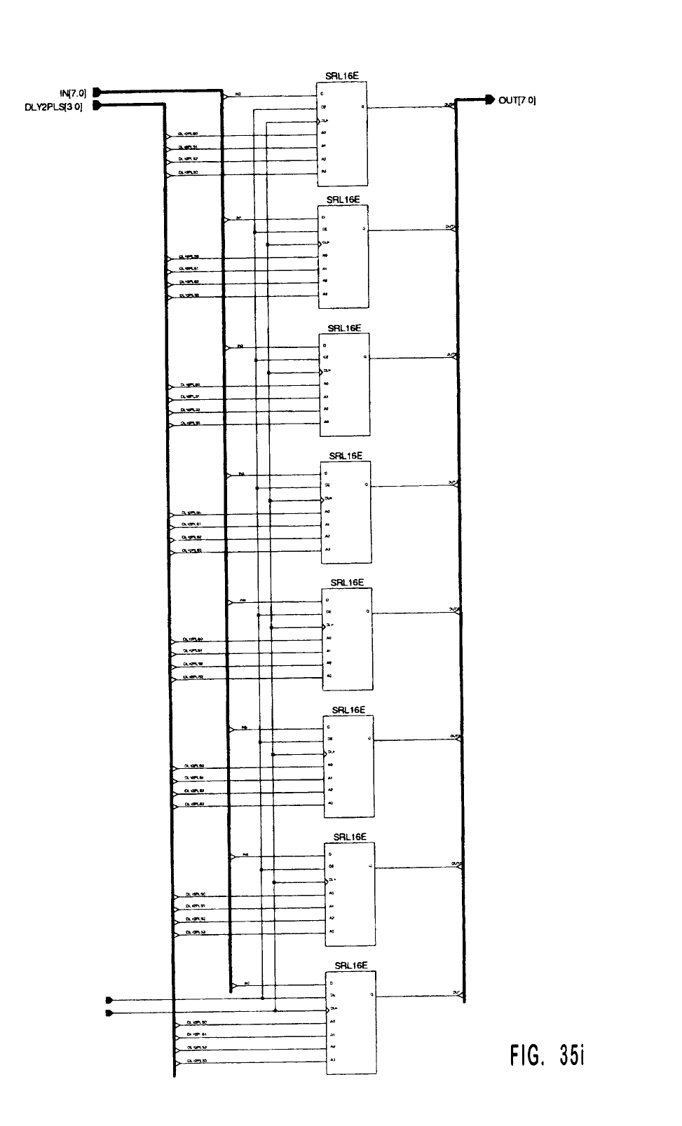

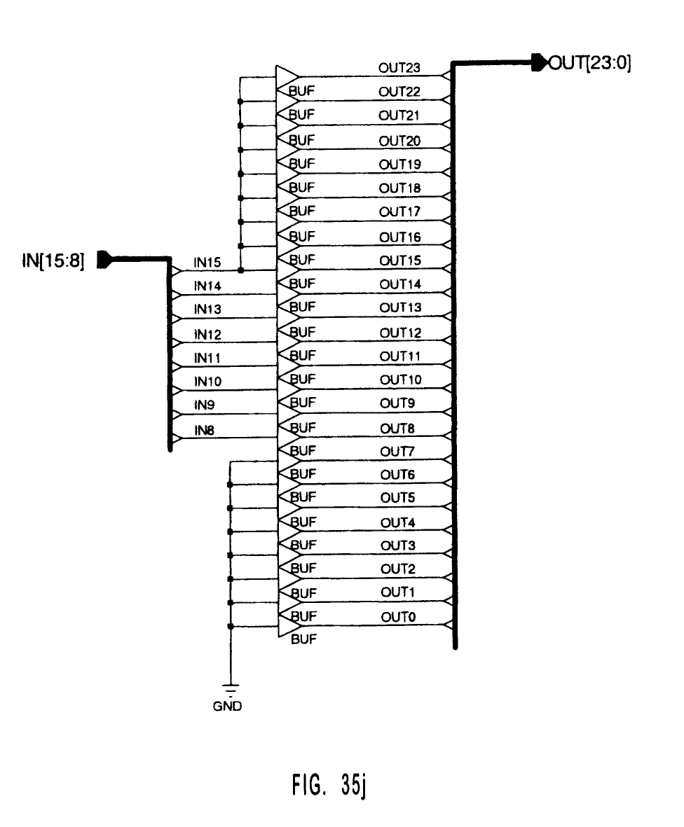

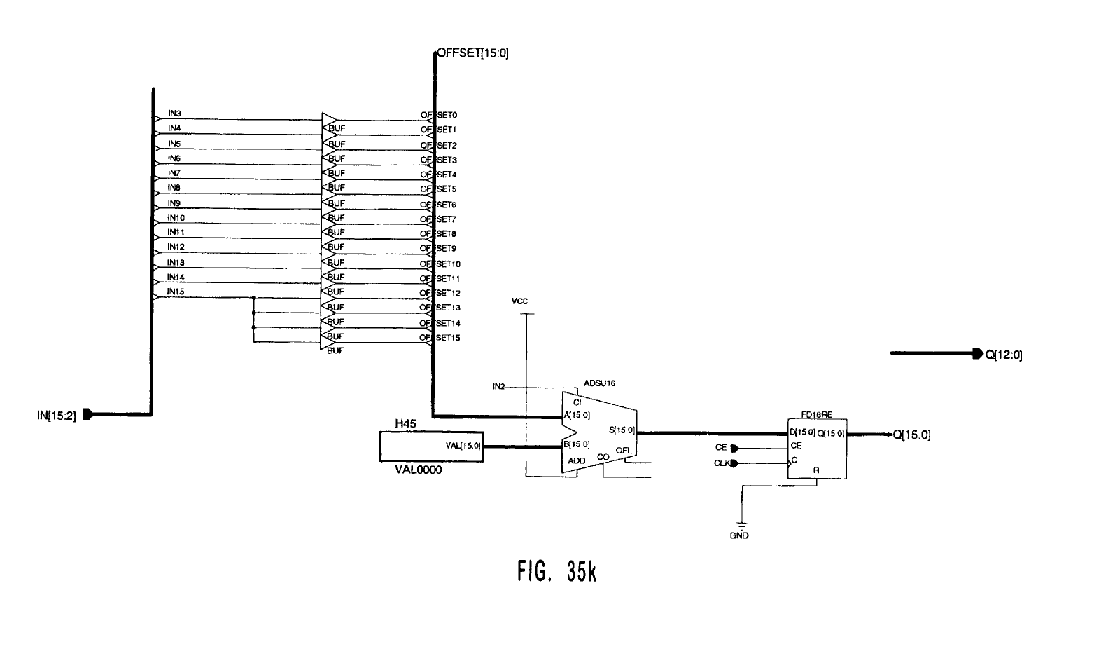

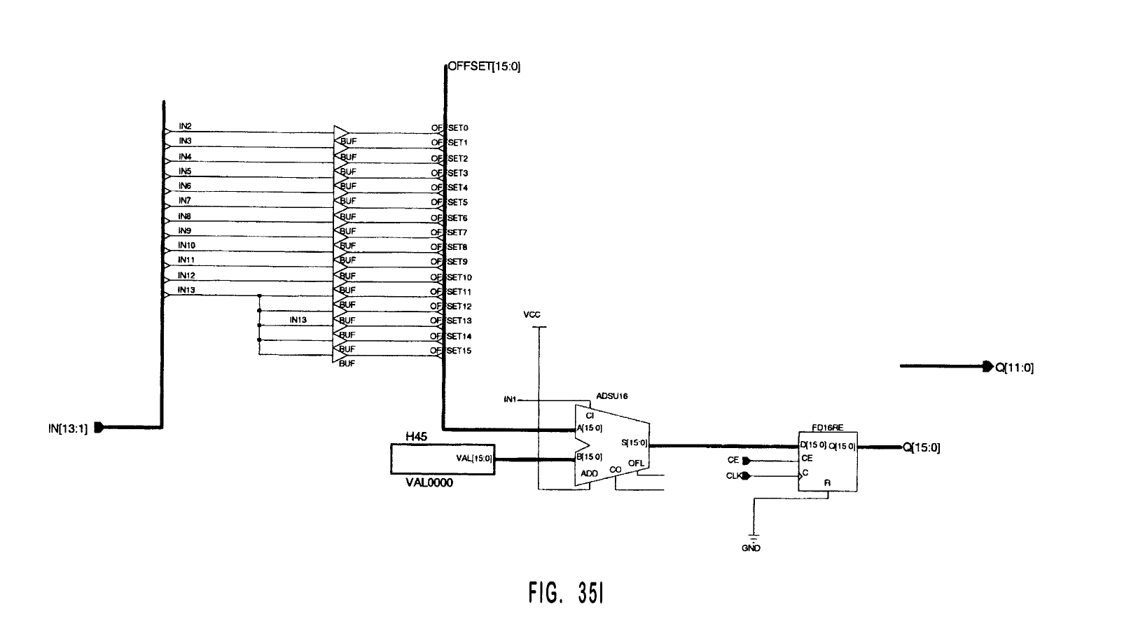

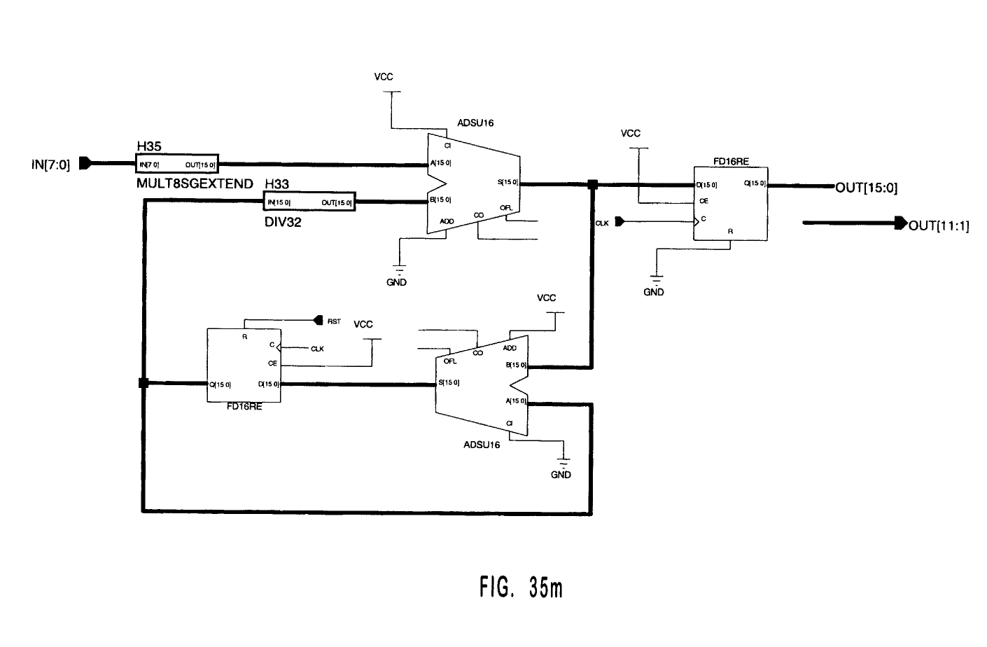

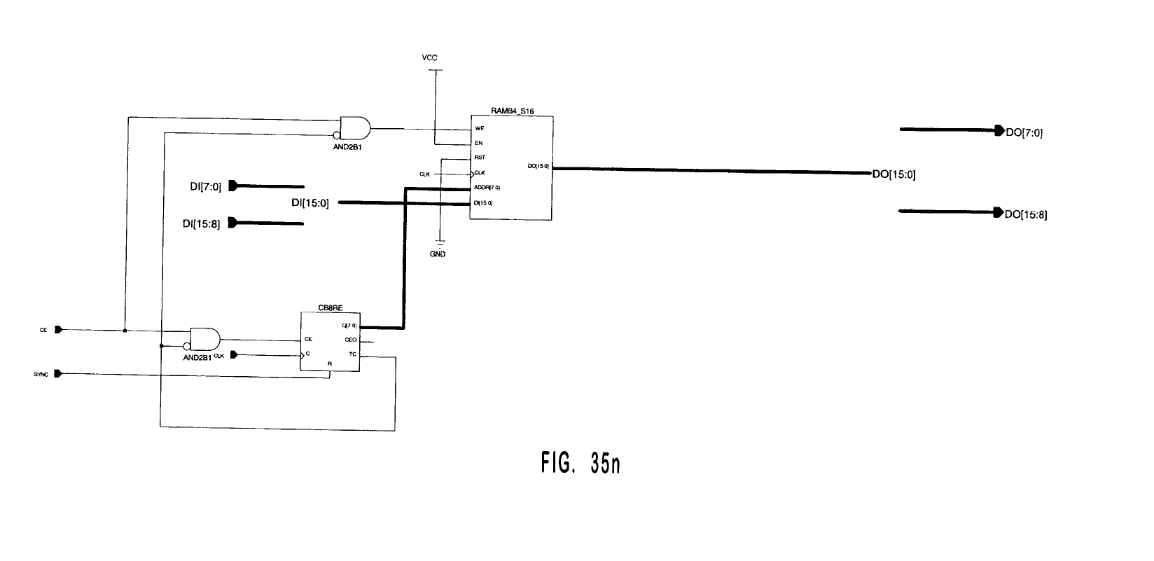

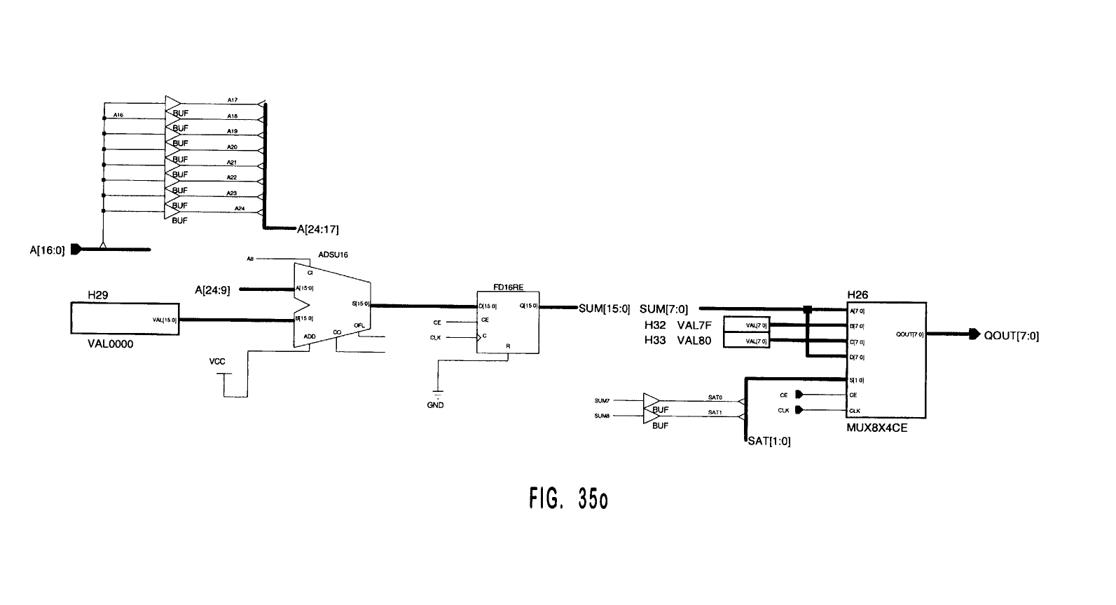

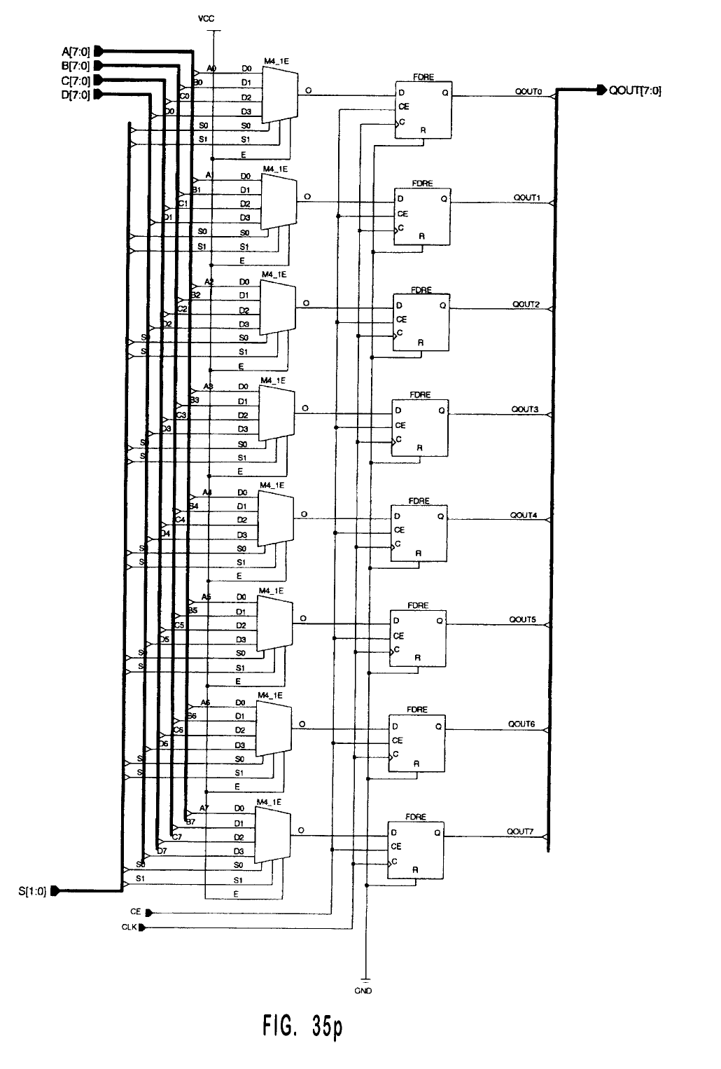

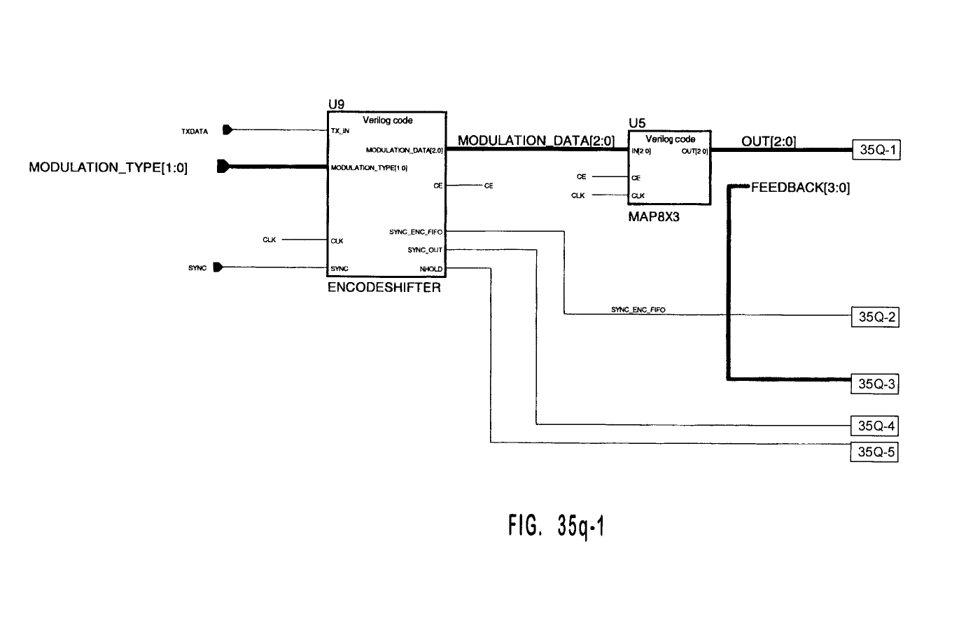

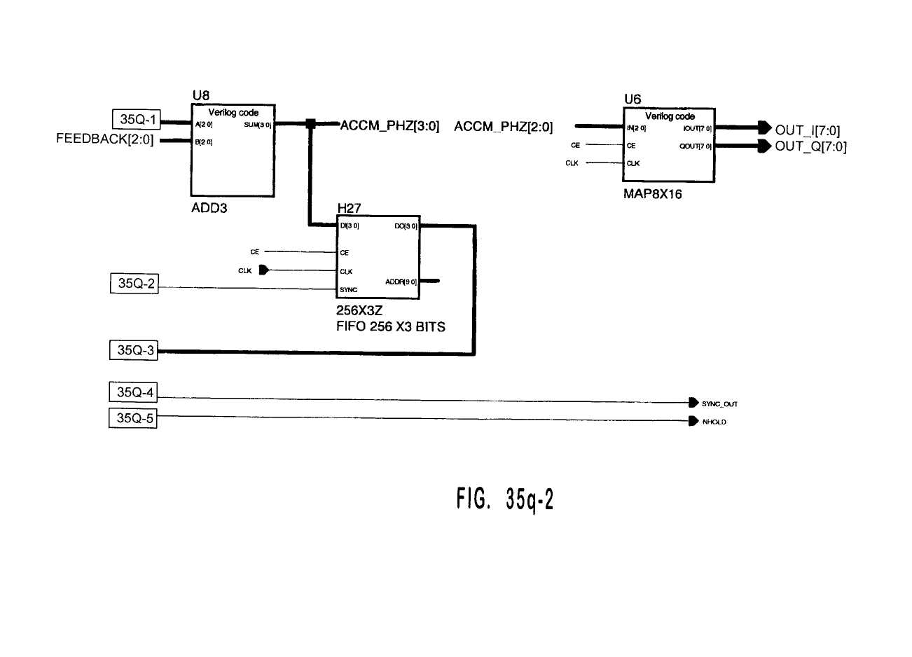

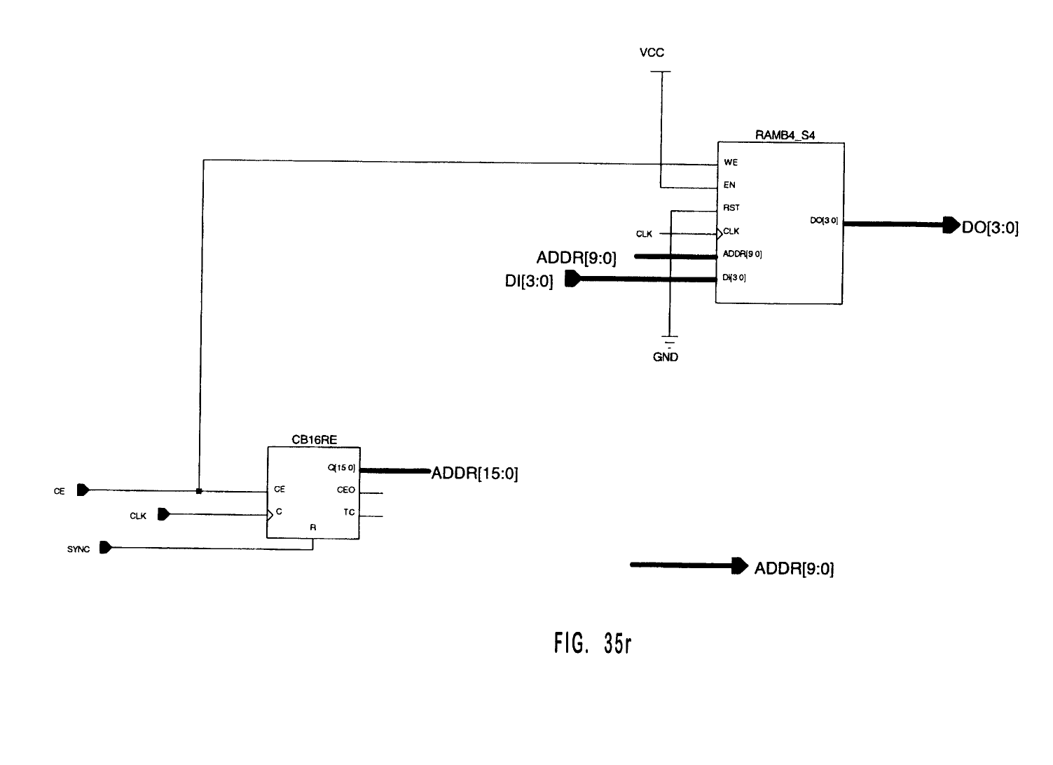

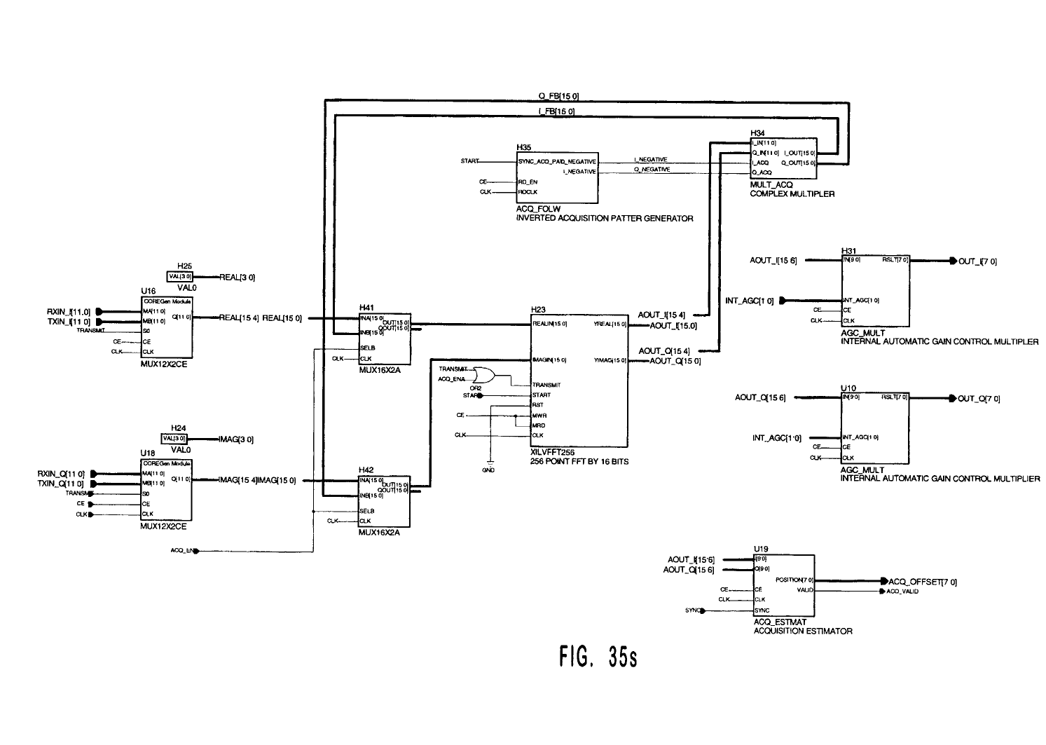

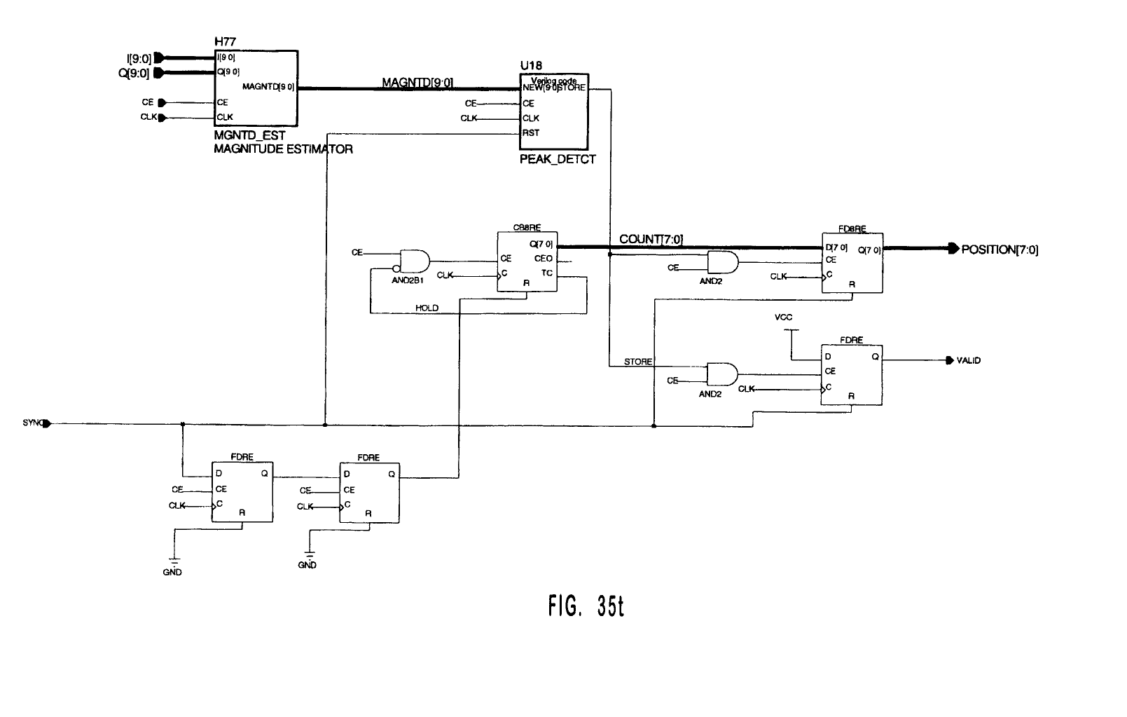

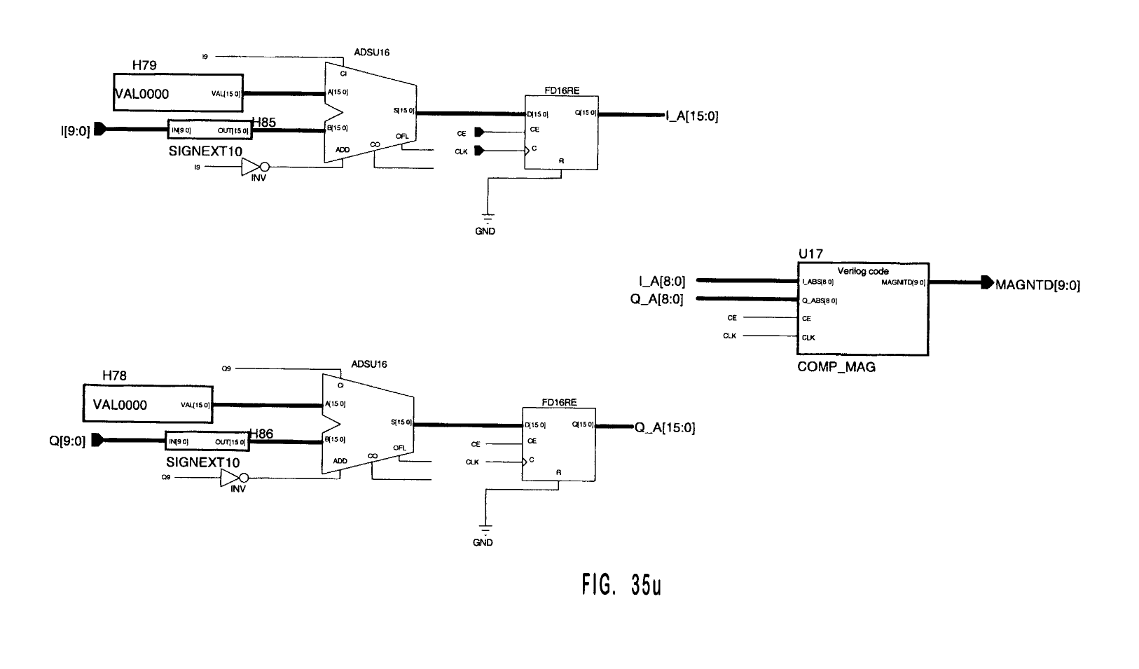

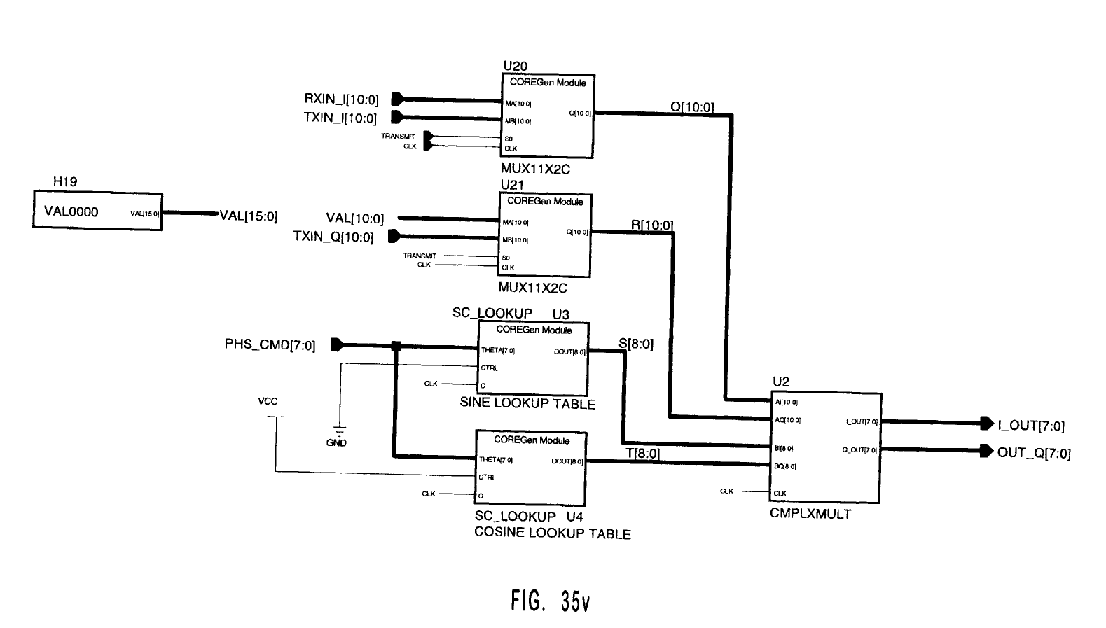

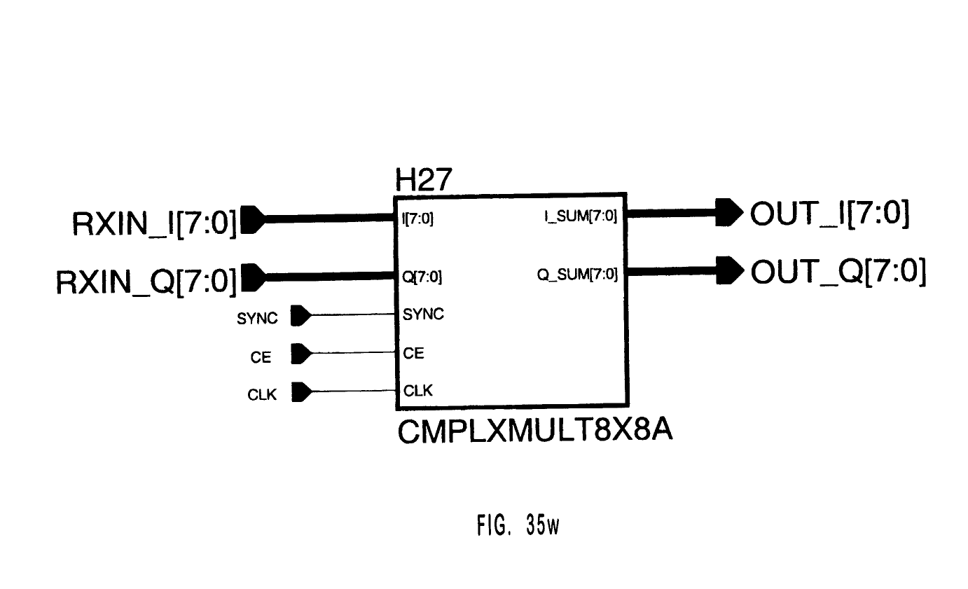

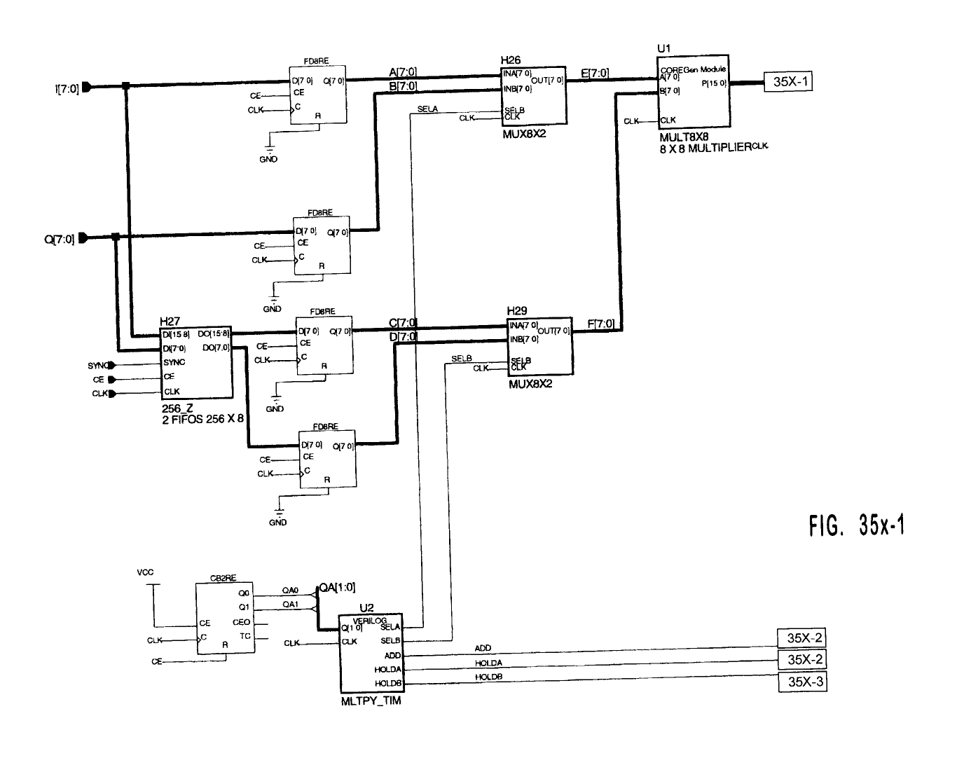

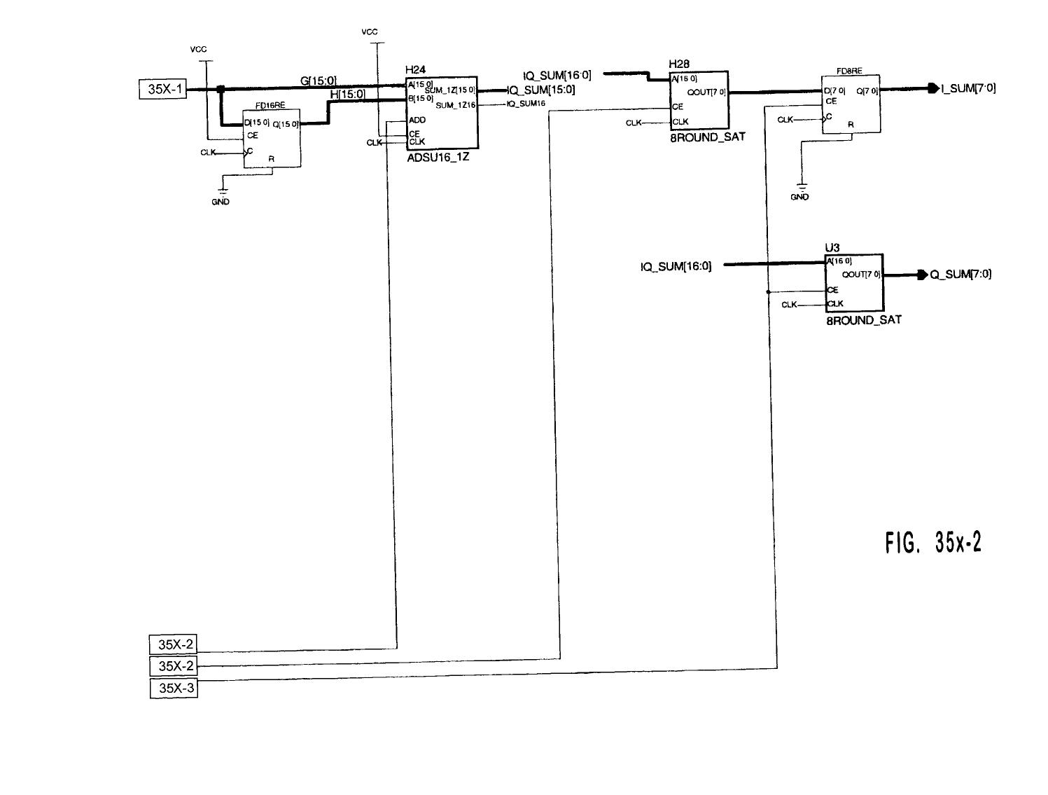

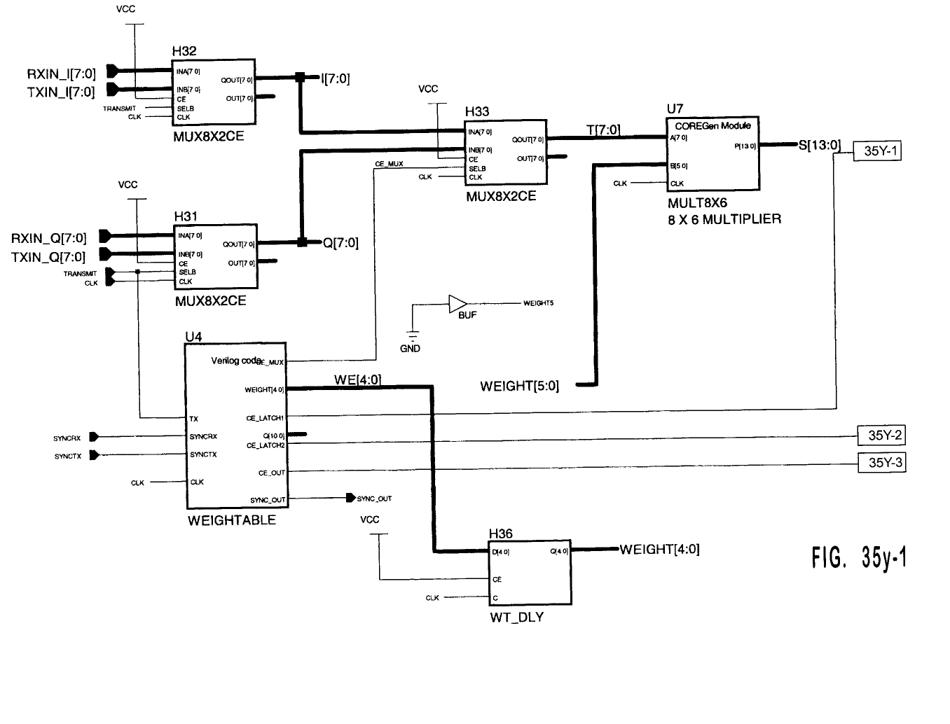

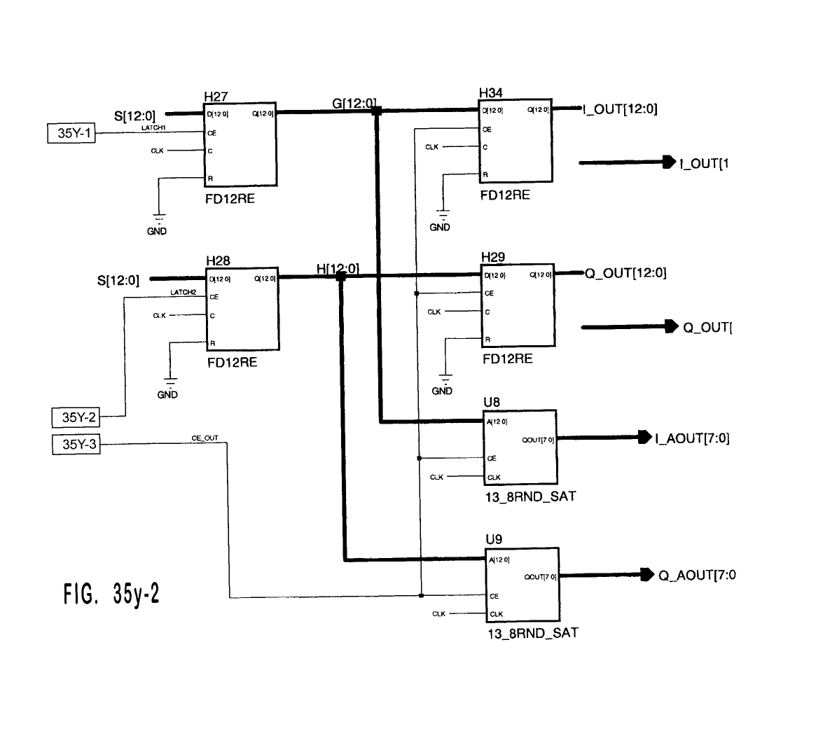

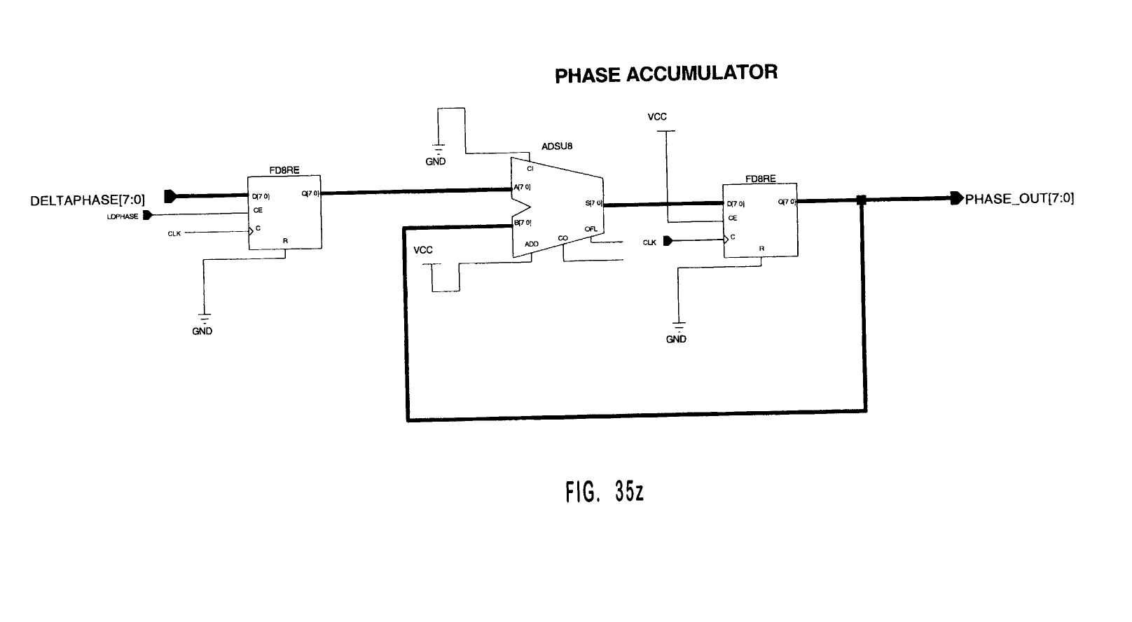

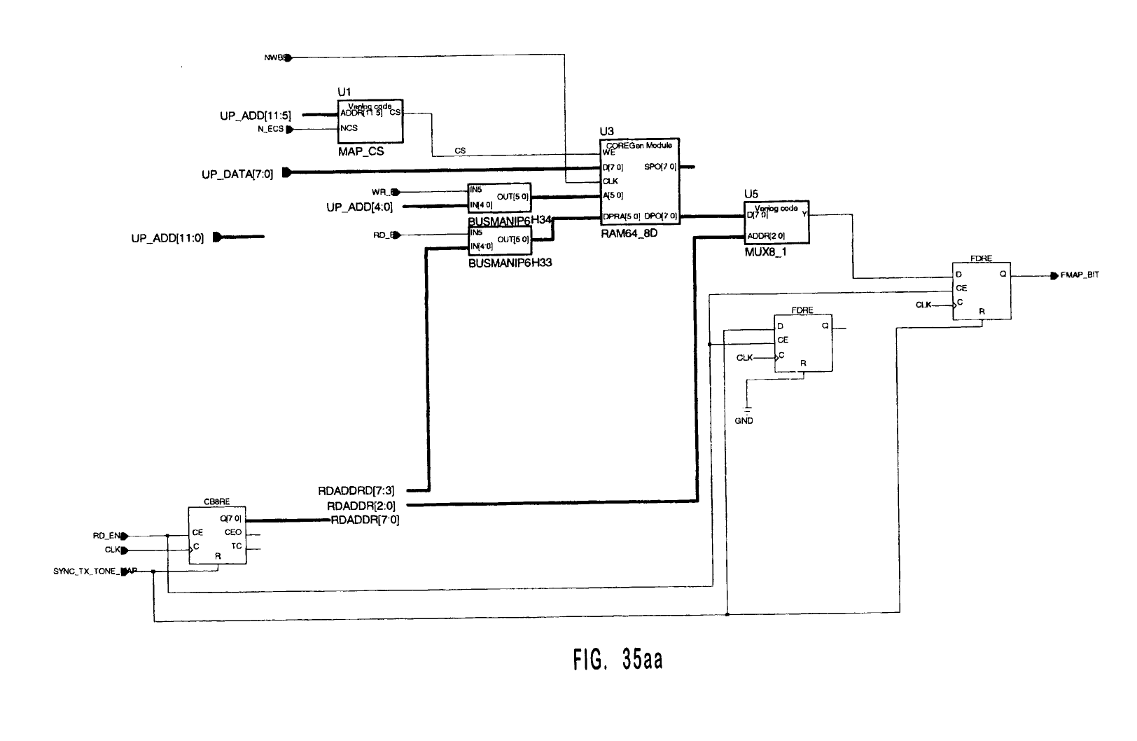

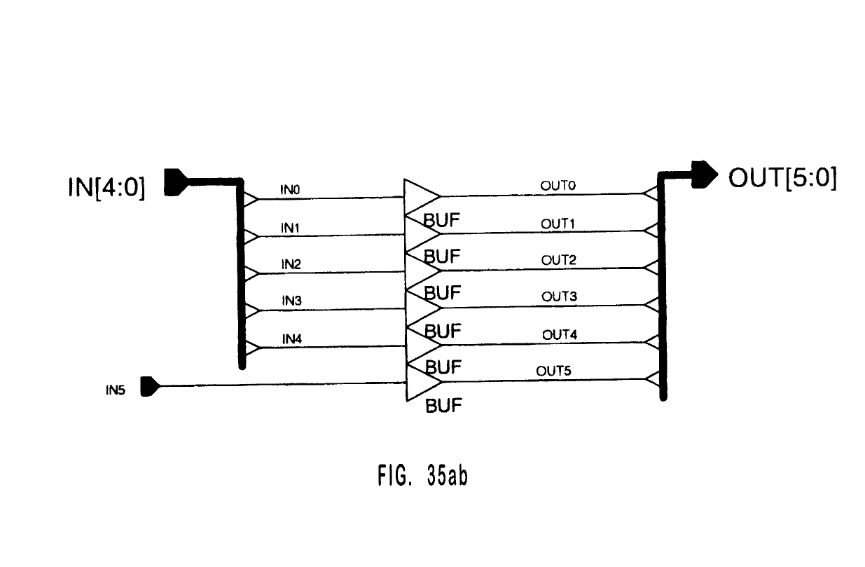

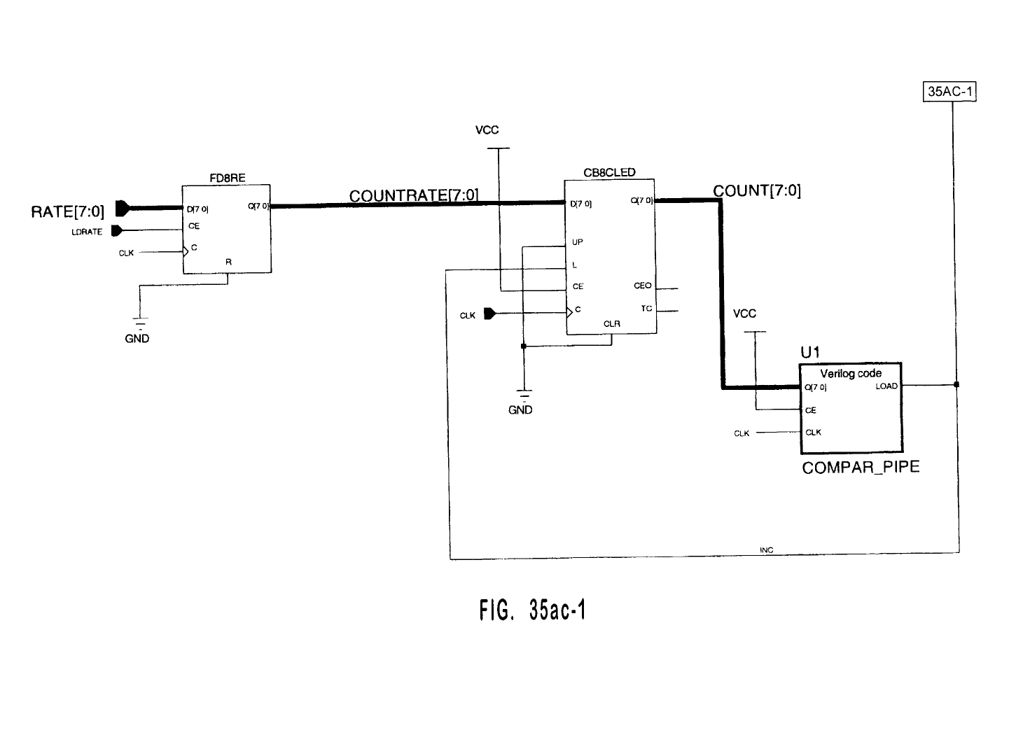

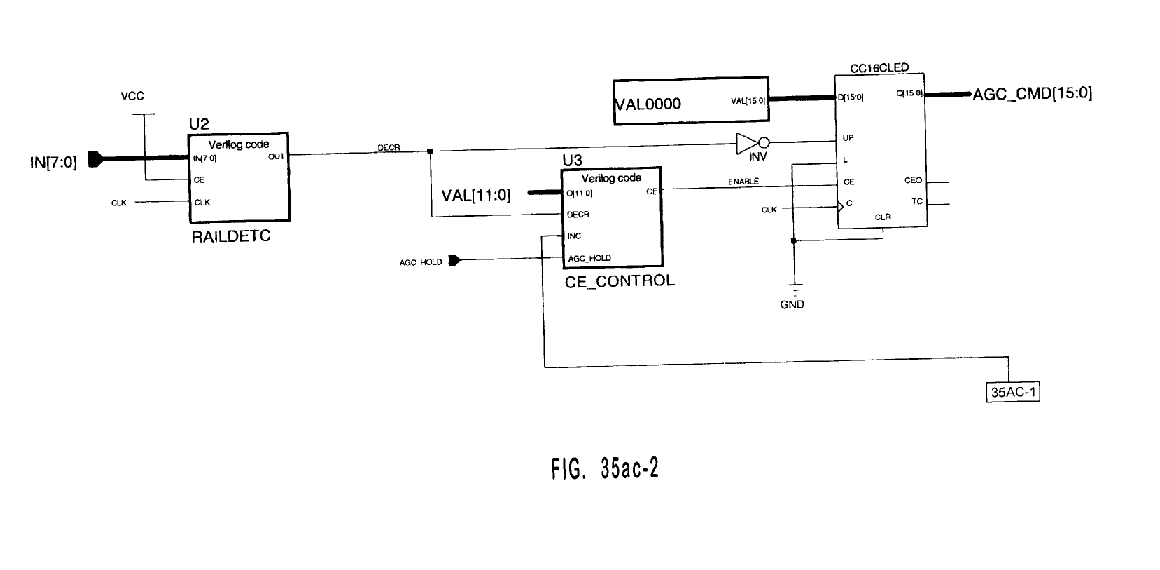

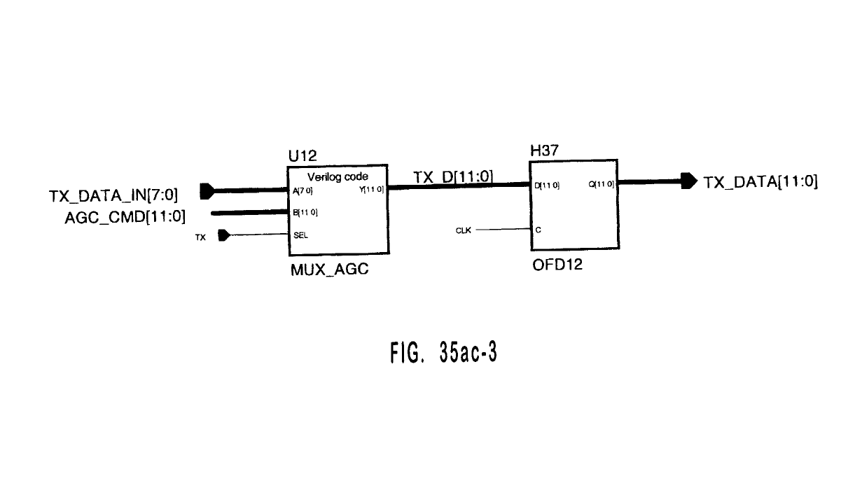

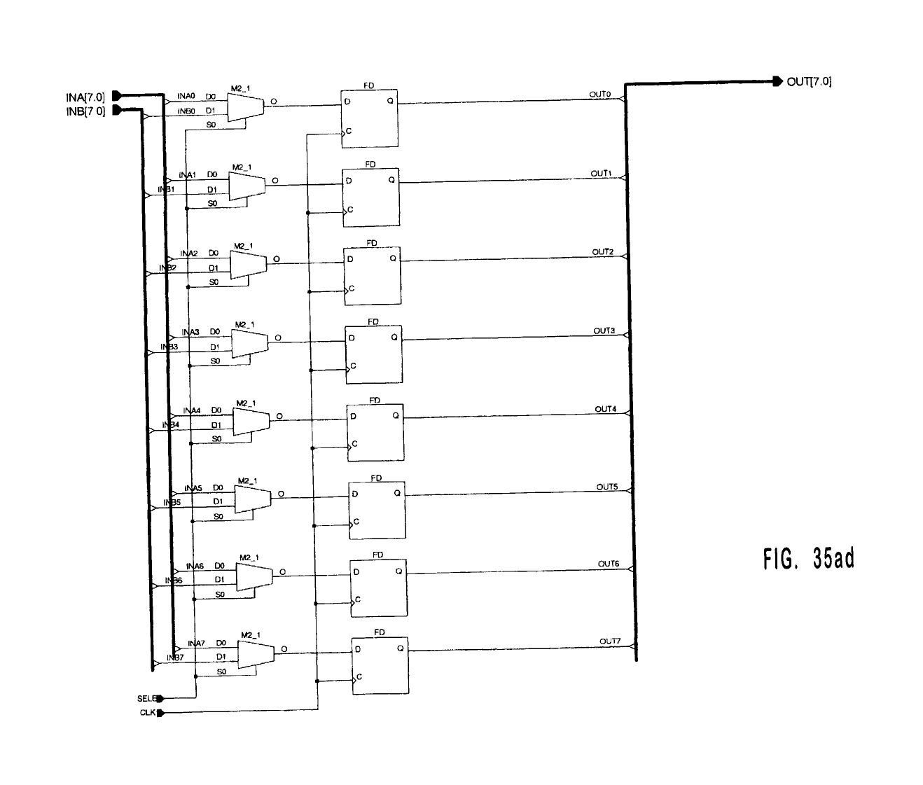

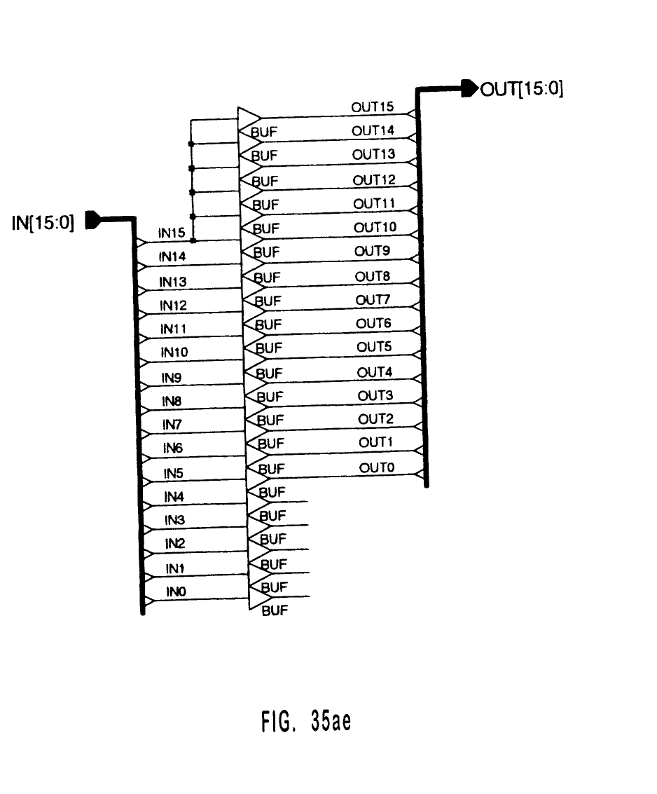

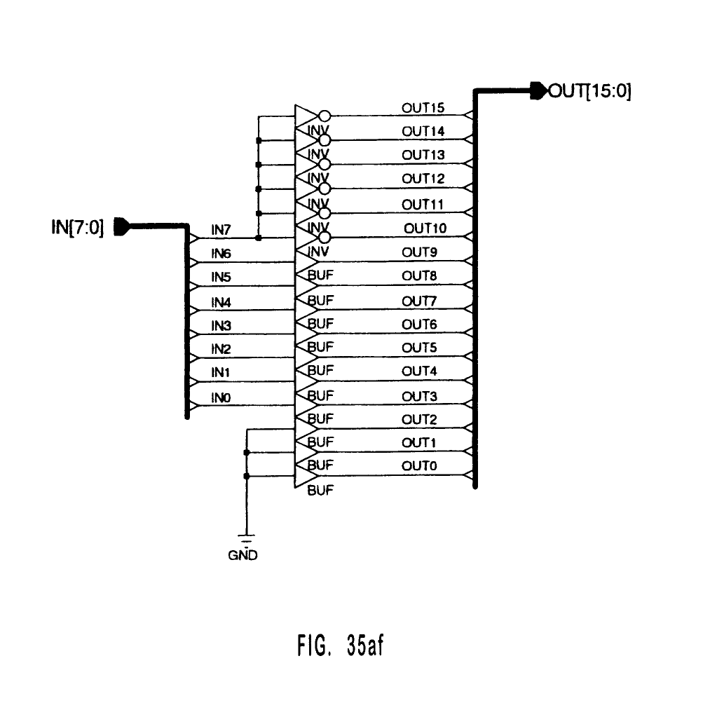

FIGS. 35a-ee are the current preferred electronic schematics of the preferred embodiment of this invention. These schematics provide the preferred electronic embodiment of this invention.

The described embodiment of this invention are to be considered in all respects only as illustrative and not as restrictive. Although specific code and electronic schematics are provided, the invention is not limited thereto. The scope of this invention is, therefore, indicated by the claims rather than by the foregoing description. All changes which come within the meaning and range of equivalency of the claims are to be embraced within their scope.

1.A system for providing a communication data link, comprising:
(A)a base unit, having a modulator and a demodulator;
(B)an extension unit, having a modulator and a demodulator; and
(C)a power line communication channel connecting said base unit with said extension unit.

2.A system for providing a communication data link, as recited in claim 1, wherein said modulator of said base unit further comprises:
(1)an encryptor;
(2)an encoder electrically connected to said encryptor;
(3)an interleaver electrically connected to said encoder;
(4)a differential encoder electrically connected to said interleaver;
(5)a channel mapper electrically connected to said differential encoder;
(6)a specific modulator electrically connected to said channel mapper;
(7)an upsampler and filter electrically connected to said specific modulator;
(8)an upconverter electrically connected to said upsampler and filter;
(9)a D/A converter electrically connected to said upconverter;
(10)a power coupler electrically connected to said D/A converter; and
(11)a connector connecting said power coupler to said AC power line.

3.A system for providing a communication data link, as recited in claim 1, wherein said modulator of said extension unit further comprises:
(1)an encryptor;
(2)an encoder electrically connected to said encryptor;
(3)an interleaver electrically connected to said encoder;
(4)a differential encoder electrically connected to said interleaver;
(5)a channel mapper electrically connected to said differential encoder;
(6)a specific modulator electrically connected to said channel mapper;
(7)an upsampler and filter electrically connected to said specific modulator;
(8)an upconverter electrically connected to said upsampler and filter;
(9)a D/A converter electrically connected to said upconverter;
(10)a power coupler electrically connected to said D/A converter; and
(10)a connector connecting said power coupler to said AC power line.

4.A system for providing a communication data link, as recited in claim 1, wherein said demodulator of said base unit further comprises:
(1)a power line coupler electrically connected to said AC power line;
(2)an A/D converter electrically connected to said power line coupler;
(3)an IF to baseband converter electrically connected to said A/D converter;
(4)a down sampler electrically connected to said IF to baseband converter;
(5)specific demodulator electrically connected to said down sampler;
(6)a channel demapper electrically connected to said specific demodulator;
(7)differential decoder electrically connected to said channel demapper;
(8)a decoder electrically connected to said differential decoder; and
(9)a decryptor electrically connected to said decoder.

5.A system for providing a communication data link, as recited in claim 1, wherein said demodulator of said extension unit further comprises:
(1)a power line coupler electrically connected to said AC power line;
(2)an A/D converter electrically connected to said power line coupler;
(3)an IF to baseband converter electrically connected to said A/D converter;
(4)a down sampler electrically connected to said IF to baseband converter;
(5)specific demodulator electrically connected to said down sampler;
(6)a channel demapper electrically connected to said specific demodulator;
(7)differential decoder electrically connected to said channel demapper;
(8)a decoder electrically connected to said differential decoder; and
(9)a decryptor electrically connected to said decoder.
